(19) United States
(12) Patent Application Publication
(10) Pub. No.: US 2013/0198112 A1
(43) Pub. Date: Aug. 1, 2013

(54) Capacity Management Methods and Systems

(71) Applicant: Venkataramana Bhat, Plano, TX (US)

(72) Inventor: Venkataramana Bhat, Plano, TX (US)

(73) Assignee: VERIZON PATENT AND LICENSING INC., Basking Ridge, NJ (US)

(21) Appl. No.: 13/361,667

(22) Filed: Jan. 30, 2012

(51) Int. Cl. G06F 15/00; G06F 15/173

(52) U.S. Cl. 705/400; 709/223

(57) ABSTRACT

An exemplary method includes a capacity management subsystem 1) receiving identification of a first computing subsystem included in a plurality of computing subsystems, 2) receiving identification of a plurality of services provided by the first computing subsystem, the plurality of services utilized in a product flow for providing a product to end users, 3) receiving data defining, for each service included in the plurality of services, an apportioned capacity of the first computing subsystem to provide the service, wherein each apportioned capacity of the first computing subsystem comprises a portion of an overall resource capacity of the first computing subsystem, 4) receiving data defining an overall operating cost of the first computing subsystem, and 5) determining an operating cost of providing each service included in the plurality of services by the first computing subsystem. Corresponding methods and systems are also disclosed.

### BACKGROUND INFORMATION

Delivery of a network circuit-based product (e.g., a private internet protocol (“PIP”) service or product, a switched circuit service or product, an Internet-based service or product, or a telecommunication-based service or product) to a customer by a network provider typically involves collaboration and coordination between numerous system elements. Managing system resources dedicated to the system elements ensures that products and services associated with the products are delivered to customers in a reliable and timely manner. Failure by a particular system or system element to maintain sufficient capacity to deliver one or more services associated with a particular product may result in delayed delivery of the network circuit-based product, a dissatisfied customer, and lost revenue for the network provider. Additionally, improper allocation of available system resources to system elements providing the products and services associated with the products may results in inefficient utilization of available system resources and wasted costs to maintain under-utilized capacity.

Unfortunately, system resource capacities for system elements utilized in the delivery of network circuit-based products are conventionally managed on a macro level by tracking overall system resources consumed by the system elements. Additionally, labor intensive manual steps are traditionally used to determine the resource capacities of the system elements involved in delivering network circuit-based products. Oftentimes, systems and system elements utilized in delivering network circuit-based products are located in separate locations, including separate local network locations and/or separate cloud-based networks. Hence, system resource capacities utilized for delivering services included in network circuit-based products may be inefficiently monitored and managed, leading to unnecessary costs and/or delays in product delivery.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary capacity management system according to principles described herein.

FIG. 2 illustrates an exemplary configuration wherein the capacity management system of FIG. 1 is communicatively coupled to a plurality of computing subsystems according to principles described herein.

FIG. 3 illustrates an exemplary configuration wherein the capacity management system of FIG. 1 is communicatively coupled to a plurality of computing subsystems providing product services according to principles described herein.

FIG. 4A-4C illustrate exemplary product flows for providing network circuit-based products to end users according to principles described herein.

FIG. 5 illustrates an exemplary configuration wherein the capacity management system of FIG. 1 is communicatively coupled to a plurality of computing subsystems providing product services according to principles described herein.

FIG. 6 illustrates an exemplary capacity management method according to principles described herein.

FIGS. 7-13 illustrate various graphical user interfaces (“GUIs”) that may be displayed according to principles described herein.

FIGS. 14A and 14B illustrate various graphical capacity management reports according to principles described herein.

FIGS. 15-18 illustrate various GUIs that may be displayed according to principles described herein.

FIG. 19 illustrates an exemplary capacity management method according to principles described herein.

FIG. 20 illustrates an exemplary capacity management method according to principles described herein.

FIG. 21 illustrates an exemplary computing device according to principles described herein.

### DETAILED DESCRIPTION OF PREFERRED EMBODIMENTS

Capacity management methods and systems are described herein. As described in detail herein, a system operated by a network provider may deliver a network circuit-based product to a customer. The delivery may include separate network provider system elements located on one or more networks performing various product flow steps included in a product flow to deliver the network circuit-based product to the customer. The performance of the various product flow steps included in the product flow may include system elements providing various services used in the product flow to deliver the network circuit-based product to the customer. In some examples, system elements that provide the services may be part of one or more discrete cloud-based network environments.

Exemplary capacity management methods and systems described herein may provide end-to-end visibility and management by a user (e.g., a system administrator) into various resource capacity and cost issues associated with delivering a network circuit-based product to a customer. For example, the methods and systems described herein may enable a user to analyze actual and projected resource capacity and cost data for various system resources on a service, element, system, and/or product flow level. The analyzed capacity and cost data may enable a network provider to better allocate system resources so as to minimize costs and prepare for expected variations in system resource capacities and usage demands. This, in turn, may allow a network provider to provide more efficient, effective, and profitable products to its customers. These and additional or alternative benefits and/or advantages that may be provided by the exemplary systems and methods will be made apparent herein.

As used herein, a “network circuit” refers to any network-based communication path and associated components that may be provided by, used by, and/or otherwise associated with a network provider and/or customer of the network provider. For example, a network circuit may include a telecommunication circuit, a dedicated circuit, a switched circuit, an analog circuit, a digital circuit, a network path for a local area network and/or a wide area network, a digital signal (“DS”) circuit (e.g., a T1, T2, or T3 line), and/or any other network-based communication path and associated components as may serve a particular implementation.

A “network circuit-based product” refers to any product and/or package of services associated with a network circuit and that may be offered by a network provider and/or any other entity to one or more customers. Exemplary network circuit-based products include, but are not limited to, private internet protocol (“PIP”) services and products, switched circuit services and products, Internet-based services and products, telecommunication-based services and products, and synchronous optical networking (“SONET”)-based services and products.

A “product flow” refers to a particular process that includes a series of steps involved in delivering a network circuit-based product to a customer. Each “product flow step” includes one or more “product flow tasks,” which refer to specific procedures, jobs, and/or tasks that are followed or completed in order to complete each product flow step. Various services, such as application programs executed by one or more computing devices, may be utilized in various product flow steps. Services used in delivering a network circuit-based product may be provided by various network provider system elements, such as computing subsystems, devices, and/or components. Delivery of a network circuit-based product to a customer may require the completion of a plurality of product flow steps involving execution of a plurality of services by one or more system elements.

“Service capacity” refers to a capacity of a particular service and/or type of service provided by an entity. For example, a service provided by a particular system element may be used by one or more product flows in completely independent manners. The service capacity may be defined by (e.g., inputted by) a user on a per element basis.

“Service cost” refers to a cost of a service on a periodic basis and may be computed from an element cost using load factors of each service hosted by the corresponding element. The service cost may be calculated as described herein.

A “load factor” of a service refers to a load exerted on a system element when that service is exercised. The load factor numbers of an element are devised such that when the use of each type of service and associated load factors are summed, the sum provides the maximum capacity of the element. The load factor may be defined by (e.g., input by) the user in percentages. The total load factor percentages sum to 100% for a given system element. For example, an element may host services S1, S2 and S3, having respective load factors of 25%, 50% and 25%. These load factors may be used to proportionately distribute element costs to individual services hosted by that element.

“Element cost” refers to a cost of an element on a periodic basis (e.g., a cost to operate an element on a per month basis). Element costs may be defined by (e.g., inputted by) a user. A service cost may be computed using an element cost and load factor definitions. For example, if an element cost is $100,000 per month, and load factors for three services S1, S2 and S3 provided by the corresponding element are 25%, 50% and 25%, the individual service costs will be $25,000, $50,000 and $25,000 respectively.

“Cloud capacity” refers to a combined capacity of a given service and/or service type within a cloud-based network (“cloud”) across one or more system elements in one or more geographical locations. This capacity may be computed by aggregating the capacity of a total number of system elements. In certain embodiments, the cloud capacity may be computed by aggregating the capacity of a total number of system elements less one system element to cater for a single system element being out of service.

“Cloud cost” refers to a total cost of all system elements of a cloud-based network on a periodic basis (e.g., on a per month basis). The cloud cost may be computed based on element cost. For example, when an element is added to or removed from a cloud-based network during a particular year, the cloud cost may reflect those changes on a monthly basis and show the cost at any point in time. The cloud cost may change whenever element cost is changed.

“Product capacity” refers to the lowest capacity among all the services across all clouds used by a product to provide end to end service to a customer.

“Available capacity” or “engineered capacity” refers to a capacity provided by an installed base of various system elements and clouds. The available capacity or engineered capacity may be specified for various time intervals. For example, an available capacity for a system to provide a particular service may refer to the cumulative service capacities of various elements and/or clouds in the system to provide the service. “Capacity usage” refers to an actual measured capacity usage value at a given point in time. The measurement may be done by an automated agent, a manual process, or a combination of automated and manual processes. Each usage value may be specified with a time stamp so that capacities of multiple services, elements, clouds, and/or products can be determined for any time point.

“Delta capacity” refers to a difference between an available capacity and capacity usage at a point in time. For a future time point, the available capacity may be an actual measured number or a projected number. The delta capacity may provide insight in to “what if” scenarios. The delta capacity may be computed for a service, element, cloud, and/or product.

Exemplary capacity management methods and systems will now be described in reference to the drawings.

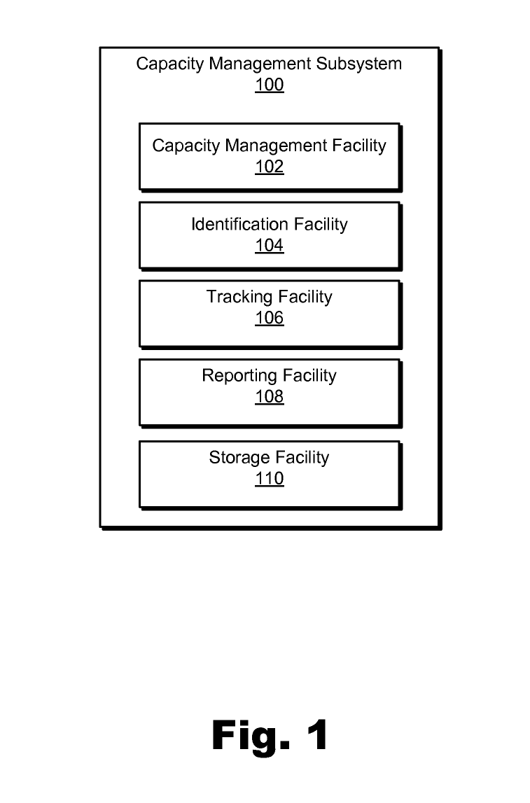

FIG. 1 illustrates an exemplary capacity management subsystem 100 (“subsystem 100”). As shown, subsystem 100 may include, without limitation, a capacity management facility 102, an identification facility 104, a tracking facility 106, a reporting facility 108, and a storage facility 110 selectively and communicatively coupled to one another. It will be recognized that although facilities 102-110 are shown to be separate facilities in FIG. 1, any of facilities 102-110 may be combined into fewer facilities, such as into a single facility, or divided into more facilities as may serve a particular implementation.

Capacity management facility 102 may be configured to perform one or more capacity management operations as may serve a particular implementation. For example, capacity management facility 102 may receive data defining apportioned capacities and corresponding costs of various system elements (e.g., computing subsystems) and/or services involved in a product flow for delivering a network circuit-based product to a customer. Capacity management facility 102 may use received data to determine system resource capacities and operating costs for providing various services on a product, element, and/or service level. Capacity management facility 102 may further be used to selectively allocate capacities of various network provider systems and/or system elements to provide services utilized in delivering network circuit-based products.

Capacity management facility 102 may receive data input from a data tracking facility, such as tracking facility 106 described below, or manual data input provided by a user. To this end, capacity management facility 102 may be configured to provide a GUI configured to facilitate manual entry and/or configuration of data. The GUI may also be configured to facilitate user-selected preferences for tracking, analyzing, and/or reporting data processed by capacity management facility 102.

Identification facility 104 may receive identification data corresponding to various network provider systems (e.g., cloud-based network systems), system elements, and/or services utilized in a product flow for delivering a network circuit-based product to a customer. For example, a user (e.g., a system administrator) may identify, to identification facility 104, one or more computing devices that provide various services utilized in a product flow. In addition to receiving identification of network provider systems, system elements, and/or services, identification facility 104 may also receive data linking various network provider systems, system elements, and/or services to each other. For example, identification facility 104 may receive an indication from a user that a particular system element, such as a computing subsystem, is capable of providing one or more specified services utilized in a particular process flow. Additionally, identification facility 104 may receive an indication from a user that the computing subsystem is located on a specified cloud-based network.

Tracking facility 106 may track various capacities and/or costs of network provider systems, system elements, and/or services. Tracking facility 106 may be used to track and organize tracked data based on specified parameters. For example, tracking facility 106 may track the total system resource capacity required by a plurality of system elements to deliver a particular service to customers during a specified time period. By way of further example, tracking facility 106 may track the total capacity used by a plurality of services provided by a particular system element.

Reporting facility 108 may provide a user with data representative of analyses of capacity and cost data in accordance with parameters specified by the user. For example, reporting facility 108 may generate reports showing and comparing available, projected, and/or actual capacities of system elements that provide services utilized in a product flow. Reporting facility 108 may also generate, by way of example, reports showing cost allocations and overall costs on a per service and/or per element basis. Reports generated by reporting facility 108 may be presented in any suitable format, including, for example, tables, graphs, and/or charts illustrating various reported values. A user may utilize the reports to effectively manage system resource capacities and lower costs while ensuring that adequate capacities are provided to meet future resource needs.

Data generated and/or used by subsystem 110, including any of the examples of data disclosed herein, may be stored in storage facility 110. Additional and/or alternative data may be stored by storage facility 110 in other embodiments.

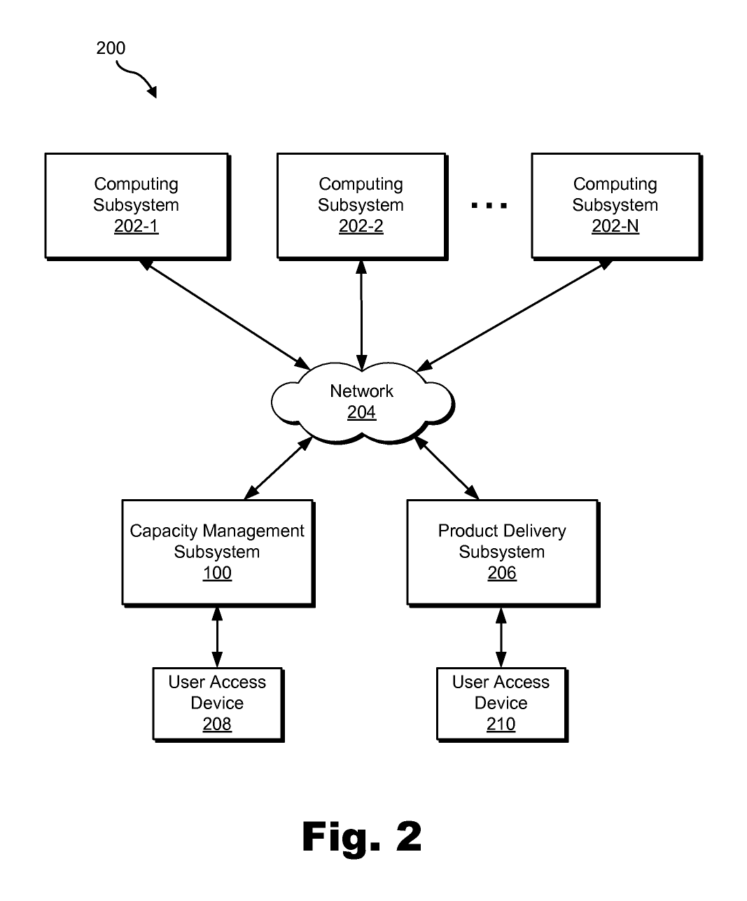

FIG. 2 illustrates an exemplary system configuration 200 wherein capacity management subsystem 100 is communicatively coupled to a plurality of computing subsystems 202 (e.g., computing subsystems 202-1 through 202-N). Each of computing subsystems 202 may include any suitable combination of computing devices configured to implement or perform one or more product flow steps carried out in a product flow that is managed by capacity management subsystem 100. For example, computing subsystems 202 may include one or more computing devices configured to perform and/or otherwise be involved with the completion of a product flow involving a plurality of product flow steps during which a plurality of services are utilized. At least one of computing subsystems 202 may be associated with a product flow used to deliver a network circuit-based product to a customer.

Capacity management subsystem 100 may communicate with computing subsystems 202 by way of a network 204. Network 204 may include one or more networks or types of networks capable of carrying communications and/or data signals between capacity management subsystem 100 and computing subsystems 202. For example, network 204 may include, but is not limited to, one or more wireless networks, broadband networks, closed media networks, cable networks, satellite networks, the Internet, intranets, local area networks, public networks, private networks, optical fiber networks, and/or any other networks capable of carrying data and communications signals between capacity management system 100 and computing subsystems 202. Additionally or alternatively, capacity management subsystem 100 may communicate directly with one or more of computing subsystems 202 without the use of network 204.

In some examples, system configuration 200 may include a product delivery subsystem 206 that communicates with computing subsystems 202 and/or capacity management subsystem 100 by way of network 204. Product delivery subsystem 206 may be configured to perform one or more product delivery operations as may serve a particular implementation. For example, product delivery subsystem 206 may receive a request from a customer to deliver a network circuit-based product to the customer. In response to the request, product delivery subsystem 206 may provide the services included in the product to the customer by directing one or more of computing subsystems 202 to execute the corresponding services for the customer. In some examples, product delivery subsystem 206 may provide or direct that the services be provided in a specified sequence in accordance with the particular network circuit-based product.

In some examples, capacity management subsystem 100, computing subsystems 202, and/or product delivery subsystem 206 may each include or be in communication with a user access device configured to facilitate user access to and/or control of one or more operations performed by capacity management subsystem 100, computing subsystems 202, and/or product delivery subsystem 206. For example, as shown in FIG. 2, capacity management subsystem 100 may be communicatively coupled to a user access device 208, and product delivery subsystem 206 may be communicatively coupled to user access device 210. User access device 208 may be configured to present one or more GUIs provided by capacity management subsystem 100 so that a user thereof may interact with capacity management subsystem 100. User access device 210 may also be configured to present one or more GUIs provided by product delivery subsystem 206 so that a user thereof may interact with product delivery subsystem 206. User access devices 208 and 210 may each include any suitable computing device such as, but not limited to, a personal computer, a communications device, a mobile device (e.g., a mobile phone or a tablet computer), a handheld device, and/or any other suitable computing device operable by a user.

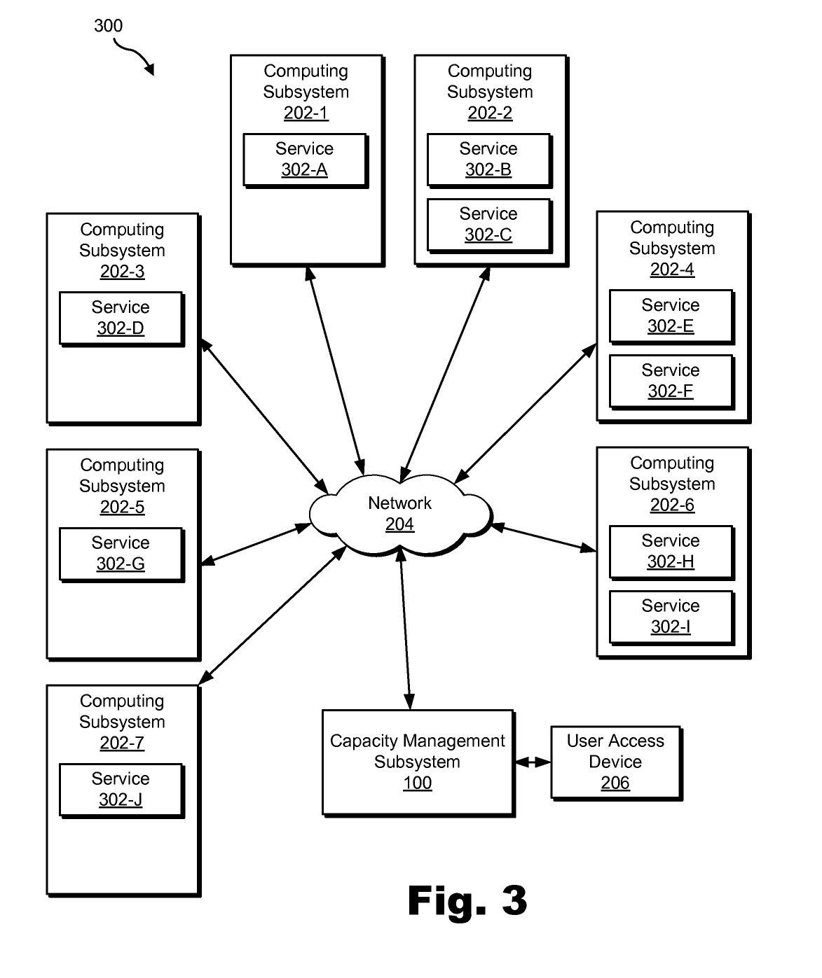

FIG. 3 illustrates an exemplary system configuration 300 wherein capacity management subsystem 100 is communicatively coupled to a plurality of computing subsystems 202 (e.g., computing subsystems 202-1 through 202-7) providing various services 302 (e.g., services 302-A through 302-J). Services 302 may be stored on or otherwise provided by one or more corresponding computing subsystems 202. Alternatively, services 302 may be stored on or otherwise provided from a location remote from corresponding computing subsystems 202. For example, at least one of computing subsystems 202 may be located within a cloud-based network such that the at least one computing subsystem 202 is located at a separate location from a data storage facility within the cloud-based network.

Services 302 may include applications and/or application packages utilized in one or more product flows for delivering a network circuit-based product to a customer. When a particular product flow is requested, one or more services 302 may be provided by at least one of computing subsystems 202. Certain services 302 may be provided in a specified order as part of a requested product flow. In some examples, different computing subsystems 202 may provide various services 302 as part of a particular product flow.

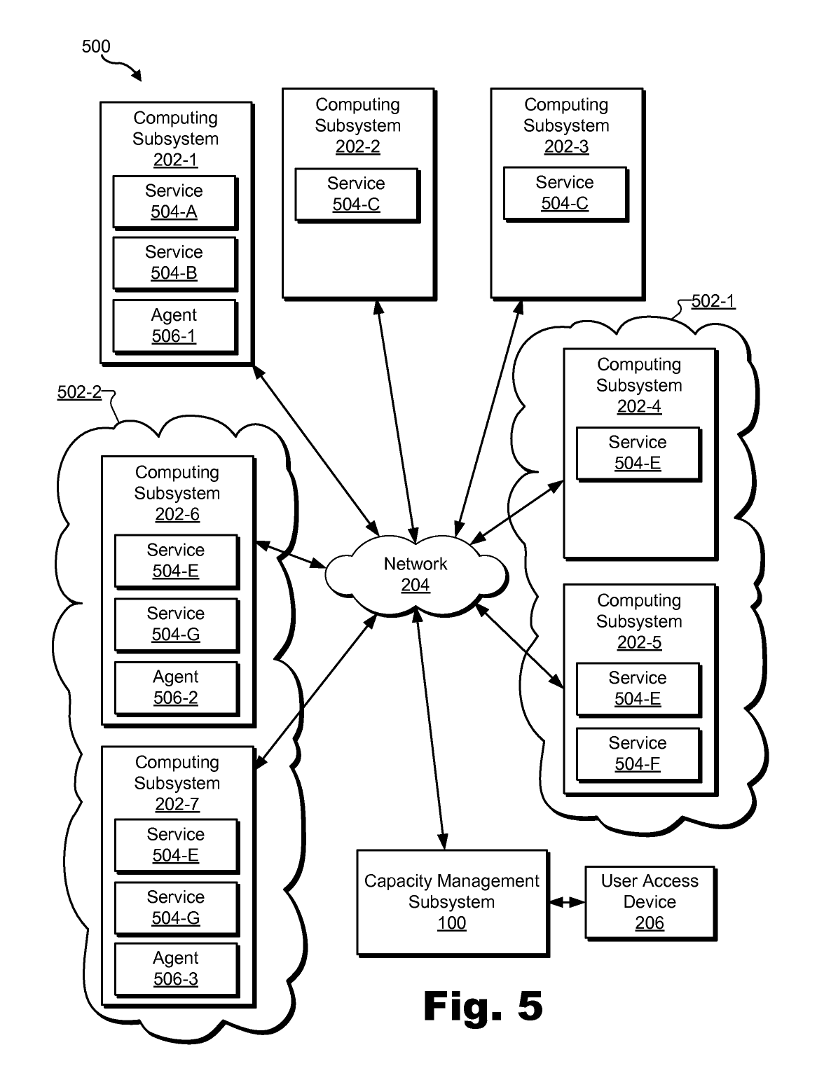

Services 302 may each be provided by one or more computing subsystems 202. Some services 302 may each be provided by only one computing subsystem 202. For example, as shown in FIG. 3, service 302-A is provided only on computing subsystem 202-1. In some examples, a particular service 302 may be provided by more than one computing subsystem 202, as will be described in greater detail below (see, e.g., FIG. 5). Additionally, some computing subsystems 202 may each provide one or more services 302. For example, as illustrated in FIG. 3, computing subsystem 202-1 may provide service 302-A, while computing subsystem 202-2 may provide service 302-B and 302-C.

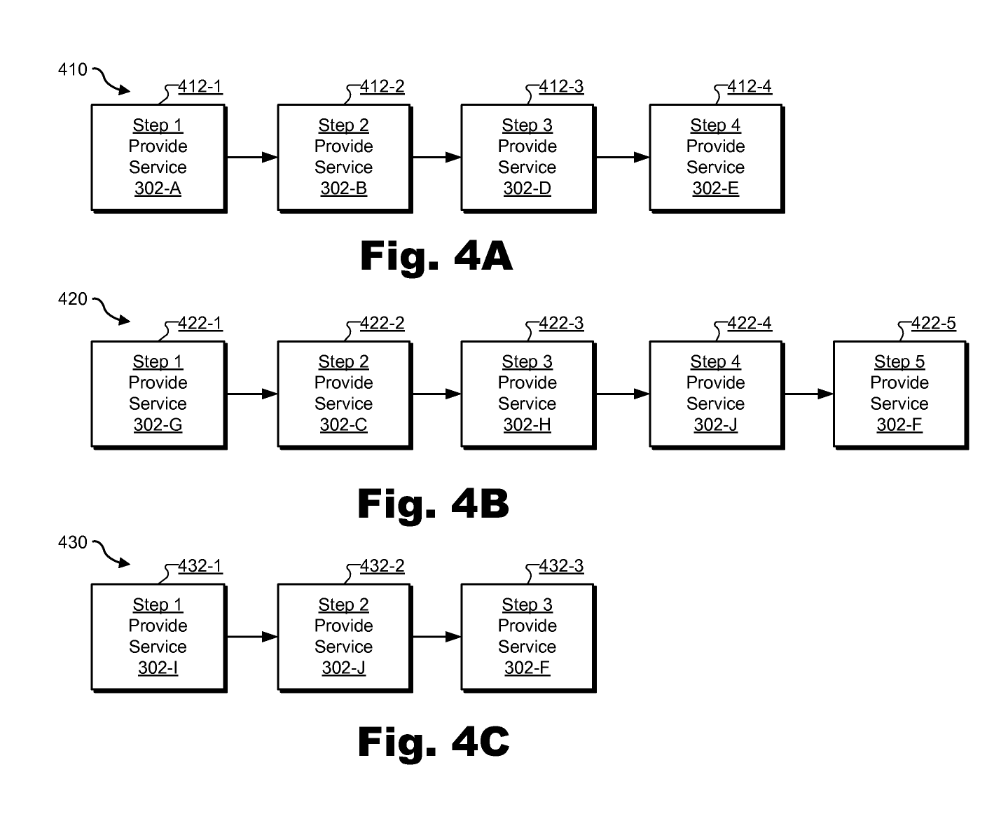

Services 302 provided by computing subsystems 202 may be utilized in various product flows for delivering various products. FIGS. 4A-4C respectively illustrate various exemplary product flows 410, 420, and 430 that include services 302 provided by computing subsystems 202 illustrated in FIG. 3. Each of product flows 410, 420, and 430 includes a plurality of product flow steps 412, 422, and 432 respectively (e.g., product flow steps 412-1 through 412-4, product flow steps 422-1 through 422-5, and product flow steps 432-1 through 432-3). As shown in FIGS. 4A-4C, various services 302 may be provided during each of product flow steps 412, 422, and 432. Some services 302 may each be specifically utilized in only one of product flows 410, 420, and 430. In other examples, a single service 302 may be utilized in multiple product flows. For example, service 302-J may be utilized in both product flow 420 and product flow 430. Additionally, a single computing subsystem 202 may be utilized in only one of product flows 410, 420, and 430, while alternatively, a single computing subsystem 202 may be utilized in two or more of product flows 410, 420, and 430. For example, computing subsystem 202-4 of configuration 300 shown in FIG. 3 may be utilized in each of product flows 410, 420, and 430.

FIG. 4A illustrates a product flow 410 that includes steps 412-1 through 412-4. During step 412-1, service 302-A may be provided by computing subsystem 202-1; during step 412-2, service 302-B may be provided by computing subsystem 202-2; during step 412-3, service 302-D may be provided by computing subsystem 202-3; and during step 412-4, service 302-E may be provided by computing subsystem 202-4. Steps 412-1 through 412-4 may be executed consecutively during process flow 410. In an alternative example, steps 412-1 through 412-4 may be executed in an order that differs from that illustrated in FIG. 4A.

FIG. 4B illustrates a product flow 420 that includes steps 422-1 through 422-5. During step 422-1, service 302-G may be provided by computing subsystem 202-5; during step 422-2, service 302-C may be provided by computing subsystem 202-2; during step 422-3, service 302-H may be provided by computing subsystem 202-6; during step 422-4, service 302-J may be provided by computing subsystem 202-7; and during step 422-5, service 302-F may be provided by computing subsystem 202-4.

As illustrated in FIGS. 4A and 4B, while no services 302 are used in both product flow 410 and product flow 420, at least one computing system 202 may be utilized in each product flow. For example, computing subsystem 202-2 is utilized during each of step 412-2 of product flow 410 and step 422-2 of product flow 420. Additionally, computing subsystem 202-4 may be utilized during each of step 412-4 of product flow 410 and step 422-5 of product flow 420.

FIG. 4C illustrates a product flow 430 that includes steps 432-1 through 432-3. During step 432-1, service 302-I may be provided by computing subsystem 202-6; during step 432-2, service 302-J may be provided by computing subsystem 202-7; and during step 432-3, service 302-F may be provided by computing subsystem 202-4.

As illustrated in FIGS. 4B and 4C, at least one service 302 may be utilized in a plurality of product flows. For example, service 302-J may be utilized during each of step 422-4 of product flow 420 and step 432-2 of product flow 430. Additionally, service 302-F may be utilized during each of step 422-5 of product flow 420 and step 432-3 of product flow 430. Further, computing subsystem 202-4 may be utilized during each of step 412-4 of product flow 410, step 422-5 of product flow 420, and step 432-3 of product flow 430.

Product flows 410, 420, and 430 may be used to deliver network circuit-based products to a customer. For example, each product flow 410, 420, and 430 may be executed in response to a request from the customer for a particular network circuit-based product. Examples of a network circuit-based product that may be delivered to a customer using a product flow, such as those illustrated in FIGS. 4A-4C, include, without limitation, a PIP product, a switched circuit product, an Internet-based product, a telecommunication-based product, and/or a SONET-based product. The product flow steps 412, 422, and 432 illustrated in FIGS. 4A-4C are merely illustrative of the many different product flow steps that may be performed by a particular system configuration such as system configuration 300. It will be recognized that one or more other systems and/or subsystems may be configured to perform one or more product flow steps associated with one or more other types of product flow processes involved in delivering a network circuit-based product to a customer.

FIG. 5 illustrates another exemplary system configuration 500 wherein capacity management subsystem 100 is communicatively coupled to a plurality of computing subsystems 202 (e.g., computing subsystems 202-1 through 202-7) providing services 504 (e.g., services 504-A through 504-J). As illustrated in FIG. 5, system configuration 500 may include computing subsystems 202 that are located on at least one cloud-based network, such as cloud-based network 502-1 and cloud-based network 502-2. System configuration 500 may also include computing subsystems 202 that are not located in a cloud-based network, such as computing subsystems 202-1 through 202-3.

Cloud-based network 502-1 and/or cloud-based network 502-2 may include Internet-based computing environments utilizing scalable system resources that are accessed via the Internet. Data, such as service applications, may be stored, accessed, and/or executed remotely within cloud-based network 502-1 and/or 502-2 using shared data centers that present a single point of access for interacting with the respective cloud-based network 502-1 or 502-2.

As illustrated in FIG. 5, some services 504 may be provided by a single computing subsystem 202. For example, services 504-A and 504-B may each be provided only by computing subsystem 202-1. Additionally, various services 504 may be provided by two or more computing subsystems 202. For example, service 504-C may be provided on both of computing subsystems 202-2 and 202-3. For example, during delivery of a product to a customer in response to a first request, computing subsystem 202-2 may be selected by system 500 to provide service 504-C. Subsequently, during delivery of the product in response to a second request, computing subsystem 202-3 may be selected by system 500 to provide service 504-C. Various factors, such as, for example, availability of resources and/or a priority hierarchy for utilizing various computing subsystems 202 may factor into a determination of which computing subsystem 202 is utilized to provide a service 504.

Agents 506 may be provided on certain computing subsystems 202. For example, as illustrated in FIG. 5, computing subsystems 202-1, 202-6, and 202-7 may each include an agent 506 (e.g., agents 506-1, 506-2, and 506-3, respectively). Agents 506 may track and send data from corresponding computing subsystems 202 to capacity management subsystem 100. For example, agent 506-1 may track and send data, such as data values indicating usage of available resources (e.g., processing resources) on computing subsystem 202-1, to tracking facility 106 of capacity management subsystem 100. By way of additional example, agent 506-2 may track and send values indicating usage of available resources (e.g., processing resources) on computing subsystem 202-6 and/or cloud-based network 502-2 to tracking facility 106.

In some examples, an available capacity for system configuration 500 to provide a particular service may indicate the cumulative service capacities of various computing subsystems 202 to provide the service. For example, the available capacity for system configuration 500 to provide service 504-E may indicate the cumulative total of service capacities for computing subsystems 202-4 and 202-5 in cloud-based network 502-1 and computing subsystems 202-6 and 202-7 in cloud-based network 502-2 to provide service 504-E.

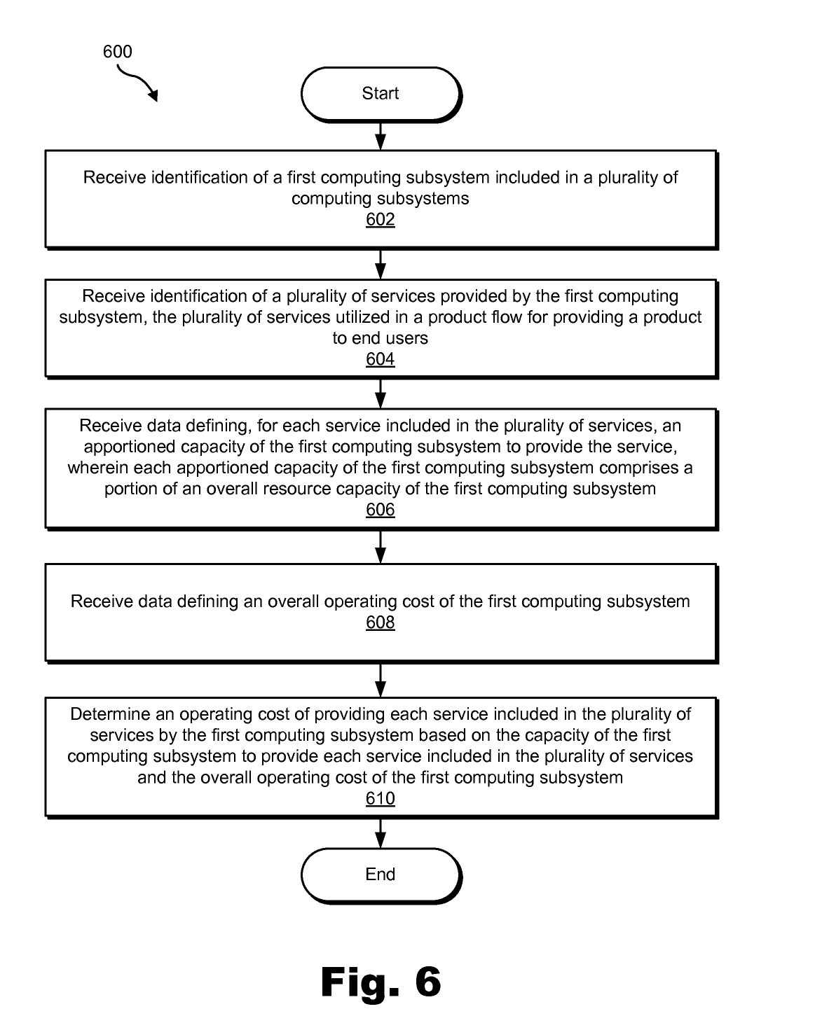

FIG. 6 illustrates an exemplary capacity management method 600. While FIG. 6 illustrates exemplary steps according to one embodiment, other embodiments may omit, add to, reorder, and/or modify any of the steps shown in FIG. 6. One or more of the steps shown in FIG. 6 may be performed by subsystem 100 and/or any implementation thereof.

In step 602, a capacity management subsystem receives identification of a first computing subsystem included in a plurality of computing subsystems. Step 602 may be performed in any of the ways described herein. For example, identification facility 104 of capacity management subsystem 100 shown in FIG. 1 may receive identification of a first computing subsystem, such as computing subsystem 202-2 illustrated in FIG. 3. In some examples a user may utilize a GUI displayed by user access device 206 to input data, such as data identifying computing subsystem 202-2, into identification facility 104.

In step 604, the capacity management subsystem receives identification of a plurality of services provided by the first computing subsystem, the plurality of services utilized in a product flow for providing a product to end users. Step 604 may be performed in any of the ways described herein. For example, identification facility 104 may receive identification of a plurality of services provided by the first computing subsystem. In some examples, for instance, an identification of services 302-B and 302-C provided by computing subsystem 202-2 may be received by identification facility 104 from a user. As shown in FIG. 4, each of services 302-B and 302-C may be utilized in at least one of product flows 410-430. In some examples, services 302-B and 302-C may both be utilized in the same product flow.

In step 606, the capacity management subsystem receives data defining, for each service included in the plurality of services, an apportioned capacity of the first computing subsystem to provide the service, wherein each apportioned capacity of the first computing subsystem comprises a portion of an overall resource capacity of the first computing subsystem. Step 606 may be performed in any of the ways described herein. For example, identification facility 104 may receive data defining, for service 302-B and service 302-C, an apportioned capacity of computing subsystem 202-2 to provide each respective service. In some examples, the apportioned capacity may define percentages of an overall resource capacity of computing subsystem 202-2 allocated to providing each of service 302-B and 302-C.

In step 608, the capacity management subsystem receives data defining an overall operating cost of the first computing subsystem. Step 608 may be performed in any of the ways described herein. For example, identification facility 104 may receive data defining an overall cost for operating computing subsystem 202-2. The operating cost may be defined on a periodic basis, such as a weekly, monthly, and/or yearly cost basis.

In step 610, the capacity management subsystem determines an operating cost of providing each service included in the plurality of services by the first computing subsystem based on the capacity of the first computing subsystem to provide each service included in the plurality of services and the overall operating cost of the first computing subsystem. For example, capacity management facility 102 may use the capacity of computing subsystem 202-2 to provide each of services 302-B and 302-C and the overall operating cost of computing subsystem 202-2 to determine an operating cost of providing each of services 302-B and 302-C by computing subsystem 202-2.

Various GUIs that may be provided for presentation by subsystem 100 will now be described. It will be recognized that the GUIs described herein are merely illustrative of the many different GUIs that may be provided for presentation by subsystem 100 in accordance with the methods and systems described herein.

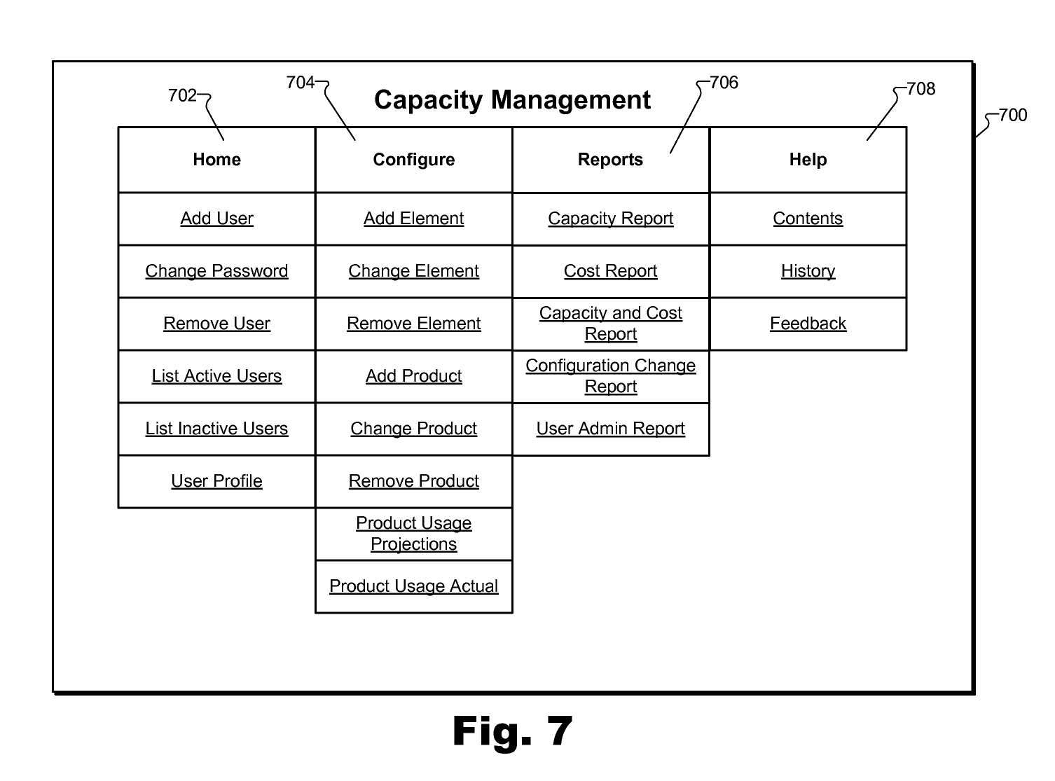

FIG. 7 shows an exemplary capacity management GUI 700 that may be provided by subsystem 100 and that is configured to facilitate user navigation of one or more features and/or functions of capacity management subsystem 100. In certain examples, GUI 700 may run on a web server and may be supported via HTTPS protocol. Any suitable device (e.g., a personal computer, tablet, smart phone, etc.) may access GUI 700 via an Internet browser. In some examples, only authorized users and/or devices may be allowed to access information, and all interactions (e.g., add/change/remove activities) may be logged. GUI 700 may allow the user to navigate between various capacity management functions by selecting a menu element displayed in GUI 700.

As shown in FIG. 7, names of various selectable options (e.g., “add user,” “change password,” “remove user,” “list active users,” “list inactive users,” and “user profile”) are shown in a home column 702. Home column 702 may include selectable options for initiating user administration operations.

Names of various selectable options (e.g., “add element,” “change element,” “remove element,” “add product,” “change product,” “remove product,” “product usage projections,” and “product usage actual”) are shown in configuration column 704. Configuration column 704 may include selectable options enabling a user to perform various configuration operations to define/change various system element properties (e.g., a computing subsystem 202 properties) and/or product properties.

Names of various selectable options (e.g., “capacity report,” “cost report,” “capacity and cost Report,” “configuration change report,” and “user admin report”) are shown in report column 706. Report column 706 may include selectable options enabling a user to generate various reports based on user-selected parameters.

Names of various selectable options (e.g., “contents,” “history,” and “feedback”) are shown in help column 708. Help column 708 may enable a user to access help on various operations and/or to provide user feedback.

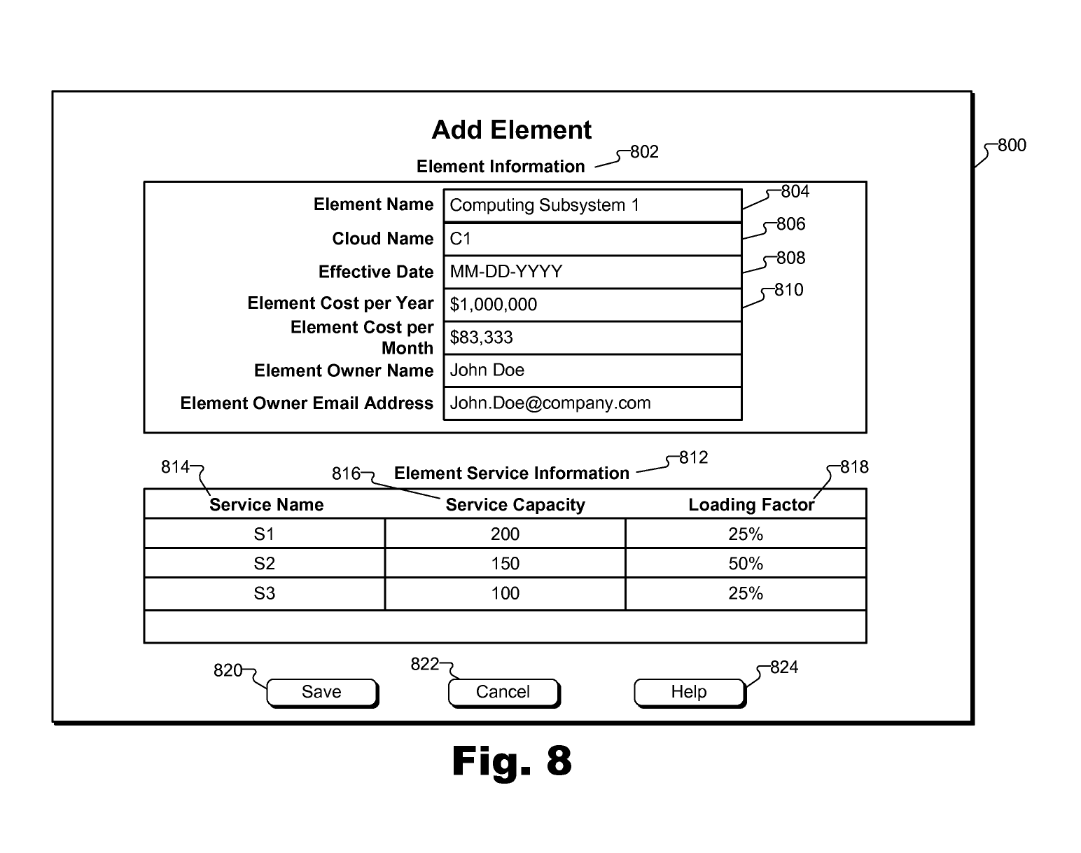

In some examples, a user may select a particular option from GUI 700 to view information and/or options associated with the selected option. For example, FIG. 8 shows an add element GUI 800 that may be provided by subsystem 100 in response to a user selecting an option to add and/or configure a system element. For example, subsystem 100 may provide GUI 800 for display in response to a user selecting an “add element” option from configuration column 704 of GUI 700 illustrated in FIG. 7. GUI 800 may enable a user to configure a system element to be tracked and/or analyzed by capacity management subsystem 100.

As shown in FIG. 8, various input fields for entering information concerning an element of a system (e.g., system 200, 300, and/or 500) into capacity management subsystem 100 may be presented within an “element information” section 802 of GUI 800. As shown, input fields may be presented within GUI 800 in a column format, with a description of the information to be input into each field presented in a column adjacent to the fields. It will be recognized that the input fields and corresponding descriptions may be alternatively presented in any other manner as may serve a particular implementation.

As shown, “element information” section 802 may include an “element name” field 804 for inputting a name of a particular element of a system (e.g., system 200, 300, and/or 500) to be added for management by capacity management subsystem 100. For example, “computing subsystem 1” may be added as an element name in field 804. Element name field 804 may be a mandatory field. The element name entered into field 804 may be a unique name of an element within a cloud-based network or a unique name across the system if the element is not specifically associated with a cloud-based network. In some examples, a user may input the name of a cloud-based network into “cloud name” field 806. For example, “computing subsystem 1” inputted into field 804 may be located in a cloud “C1.” In some examples, the element name and cloud name together are unique across the system managed by capacity management subsystem 100.

Section 802 of GUI 800 may further include an “effective date” field 808 for entering a beginning date for managing an added element by capacity management subsystem 100. The effective date is a user selected date to begin management of the selected element by capacity management subsystem 100. The effective date can be a past or future date compared to the date of entry into effective date field 808. The date in field 808 may default to the date on which the element information is entered into GUI 800.

Section 802 of GUI 800 may also include an “element cost” field 810 for entering a cost of the added element during a specified time frame. For example, a monthly and/or a yearly cost of the added element may be input into element cost field 810. Section 802 may include additional fields for inputting information concerning the added element, such as fields for entering the name and/or email address of an element owner responsible for management of the element identified in field 804. The field for entering the email address may be auto-populated if capacity management subsystem 100 is able extract this information from a company directory (e.g., an LDAP directory) and/or from any other personal information repository associated with the identified name of an element owner.

GUI 800 may also include various input fields for entering information concerning services provided by an element identified in field 804 within an “element service information” section 812 of GUI 800. Section 812 may include a “service name” column 814 having fields for inputting names of services provided by the element identified in field 804. For example, as shown in FIG. 8, services “S1,” “S2,” and “S3” may be identified in column 814. The service names entered into fields within column 814 may be unique names of services across the system managed by capacity management subsystem 100. The service names in column 814 may be selected from pull-down menus associated with each entry field in column 814. Such pull-down menus may be available, for example, when the service names have been previously input into capacity management subsystem 100. Alternatively, service names may be newly entered by the user. If a new service name is added by the user, the service name is added to storage facility 110 of capacity management subsystem 100 and may be available in pull-down list format during future operations.

“Element service information” section 812 may also include a “service capacity” column 816 and a “loading factor” column 818. The user may enter values identifying a capacity of the identified element (e.g., “Computing Subsystem 1”) to handle each corresponding service identified in “service name” column 814. The service capacity values entered into column 816 may be free-form integer numbers greater than zero indicating a capacity required to provide the corresponding service. For example, the service capacities in “service capacity” column 816 may indicate the total system resources required to provide the respective services on a periodic basis, such as, for example, on a weekly and/or monthly basis. The service capacity values may be entered into “service capacity” column 816 by a user when a corresponding service is identified in “service name” column 814. Alternatively, the service capacity values may be auto-populated in “service capacity” column 816 if capacity management subsystem 100 can extract this information from a company directory or any other personal information repository associated with the identified name of an element owner. In some examples, service capacity values may be determined from information obtained by tracking facility 106.

Loading factors entered into fields in “loading factor” column 818 may represent a portion of an overall capacity of the element identified in “element name” field 804 to provide corresponding services identified in “service name” column 814. As illustrated in FIG. 8, for example, the loading factors in “loading factor” column 818 may be expressed as percentages, with the sum total of all loading factors in “loading factor” column 818 equaling 100%. The loading factors may be determined by a user and entered into the fields in “loading factor” column 818. For example, as shown in FIG. 8, a user may specify that, out of the overall capacity of Computing Subsystem 1, 25% of the capacity be assigned to provide service S1, 50% of the capacity be assigned to provide service S2, and the remaining 25% of the capacity be assigned to provide service S3. In some examples, capacity management facility 102 of capacity management subsystem 100 may use various factors, such as historical capacity usage, historical costs, projected capacity usage, projected costs, and/or priorities assigned to various services, to determine the proper loading factors that are to be assigned to each service.

GUI 800 may also include a “save” option 820, a “cancel” option 822, and a “help” option 824. The user may select “save” option 820 to save the information entered into and/or selected in GUI 800. Upon the user's selection of “save” option 820, data representative of the element identified in “element name” field 804 may be saved in storage facility 110 of capacity management subsystem 100 in association with other information provided by the user in GUI 800. The saved information may then be utilized by capacity management facility 102 in capacity management processes. The user may select “cancel” option 822 to cancel the addition of any information entered into GUI 800. Upon selection of “cancel” option 822, GUI 800 may be closed, and capacity management GUI 700 or another screen may be displayed. The user may select “help” option 824 to pull up an explanation of the various fields in GUI 800 and/or to pull up a menu providing searchable and/or indexed help options.

Additional GUIs may be provided by capacity management subsystem 100 to enable a user to change properties of elements and/or remove elements stored in storage facility 110 of subsystem 100. For example, as shown in FIG. 7, configuration column 704 may include a “change element” option and a “remove element” option. When a user selects the “change element” option from configuration column 704, for example, a “change element” GUI may be presented to the user that allows the user to select a name of a stored element and/or a cloud-based network associated with a stored element from a menu, such as a drop-down menu. Once a desired element is selected, the user may be presented with fields showing the current configuration properties of the element, such as the properties illustrated in GUI 800 shown in FIG. 8. The user may be given the option to leave field values as they are or make changes as desired, while being prevented from changing certain values, such as the element name and/or the cloud-based network name. For example, the user may adjust the service capacity and/or loading factor associated with various services provided by the selected element. Additionally, the user may add or remove services from the services associated with the selected element. The user may also be provided with a field to enter an effective date for the changes made to the element.

In some examples, when a user selects the “remove element” option from configuration column 704 of GUI 700, a “remove element” GUI may be presented to the user that allows the user to select a name of a stored element and/or a cloud-based network associated with a stored element from a menu, such as a drop-down menu. Once a desired element is selected, the user may be presented with an option to remove the selected element. The user may also be provided with a field to enter an effective date for removal of the element. In some examples, once the user submits a request to remove an element, capacity management subsystem 100 may be updated with a “NotInService” status for the element so that the removed element is not used in any capacity or cost computation after the effective date. In some examples, an element record associated with the element may remain in the database for historic reporting purposes.

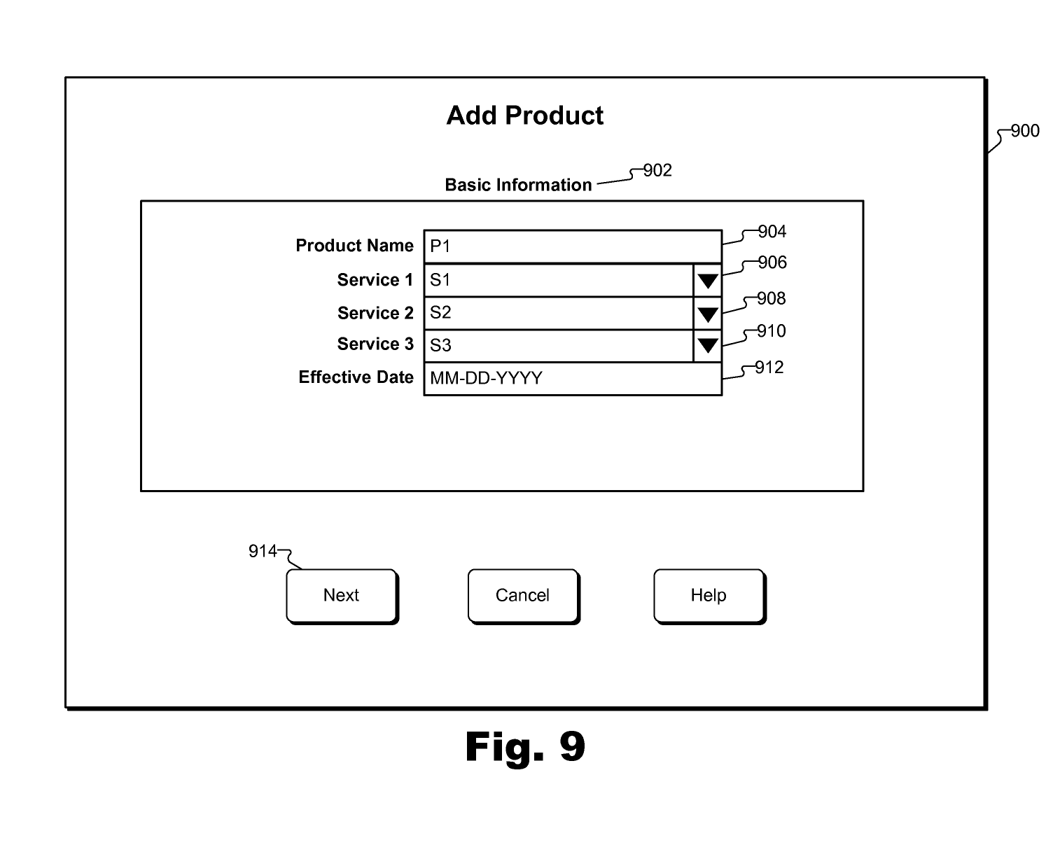

In some examples, a user may select an “add product” option from configuration column 704 of GUI 700 illustrated in FIG. 7. For example, FIG. 9 shows an add product GUI 900 that may be provided by subsystem 100 in response to a user selecting an option to add and/or configure a product. GUI 900 may enable a user to configure a product inside a cloud-based environment or in a standalone environment. As shown in FIG. 9, various types of information related to a product may be presented within a “basic information” section 902 of GUI 900. As shown, input fields may be presented within GUI 900 in a column format, with a description of information to be input into each field presented in a column adjacent to the fields. It will be recognized that the input fields and corresponding descriptions may be alternatively presented in any other manner as may serve a particular implementation.

Section 902 may include a “product name” field 904 for inputting a name of a particular product of a system (e.g., system 200, 300, and/or 500) to be added for management by capacity management subsystem 100. For example, product “P1” may be added as a product name in field 904. According to some examples, the product name entered in field 904 may be a unique name of a network circuit-based product delivered by the system to a customer.

Names of services included in the product and provided by the system may be entered into “service” fields 906, 908, and 910. Additional fields may be provided for additional product services as required. Fields 906, 908, and 910 may include fields that allow manual entry of a name of a particular service by a user. In some embodiments, as illustrated in FIG. 9, fields 906, 908, and/or 910 may each include a drop-down menu for selecting from a menu list of services provided by the system. For example, services that have been previously entered and stored in subsystem 100 in conjunction with various other elements and/or products may be displayed in drop-down menus of fields 906, 908, and/or 910. Such drop-menus may also include an option to add an additional service that is not shown in the listed services.

Section 902 of GUI 900 may further include an “effective date” field 912 for entering a beginning date for managing an added product by capacity management subsystem 100. The effective date is a user selected date to begin management of the selected product by capacity management subsystem 100. The effective date can be a past or future date compared to the date of entry into field 912. The date in field 912 may default to the date on which the information is entered into GUI 900.

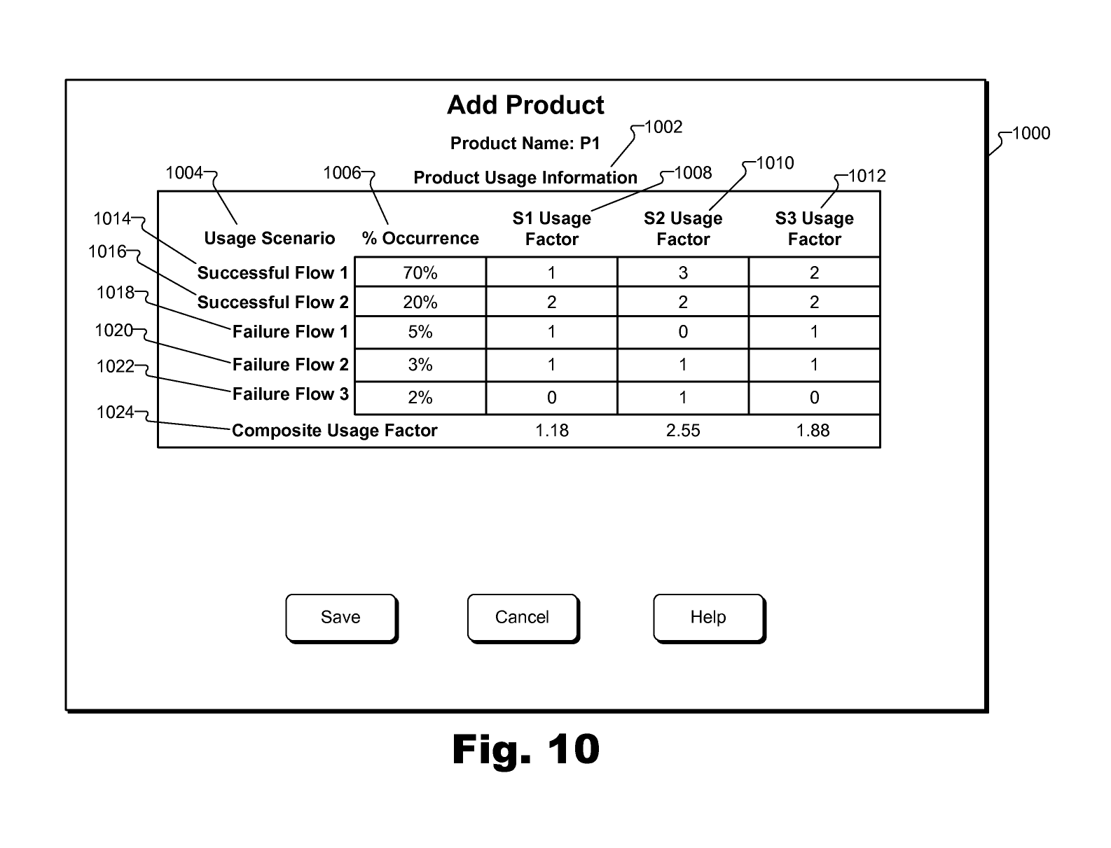

Once the user has entered the desired information into section 902 of GUI 900, the user may select a “next” option 914, which may open another “add product” GUI 1000 providing additional fields for entering product information as shown in FIG. 10. As shown, GUI 1000 may include various input fields for entering information concerning services provided by a product identified in field 904 of GUI 900 within a “product usage information” section 1002 of GUI 1000. Section 1002 may include a “usage scenario” column 1004, a “% occurrence” column 1006, and “service usage” columns 1008, 1010, and 1012.

Various types of usage scenarios that occur during delivery of a particular product to customers may be displayed under “usage scenario” column 1004. In some embodiments, the names for the different usage scenarios may be entered by the user. During delivery of a particular product, various flow scenarios may occur depending on a variety of factors. Such scenarios may include, for example, various successful or failure flows. Different successful usage scenarios may utilize various services to different extents. A successful scenario may utilize all of the services associated with the product, and the corresponding usage factors associated with the successful scenario may be high, while various failure scenarios may not use all the services associated with the product.

In some examples, in delivering a telecommunication product to a customer in response to a request, the product may be successfully provided to the customer. For example, a customer may initiate a request to the system to complete a phone call to a desired destination. The phone call may be successfully provided to the customer when the customer is connected with a desired contact or a voicemail service (e.g., a contact person or a voicemail service associated with the person). The successful delivery of the product to the customer may be classified as a successful flow. In some examples, the telecommunication product may not be delivered to the customer, or the product may be only partially delivered. For example, the product may fail to be delivered to the customer when the customer is disconnected from the system prior to completion of a phone call, when the customer receives a busy signal, or when the phone rings but is not answered. A failure to deliver the product to the customer may be classified as a failure flow.

Capacity management subsystem 100 may track and aggregate the rate of occurrence of the various types of successful and failure flows. For example, tracking facility 106 may track relative rates of occurrence of successful and failure flows. As shown in FIG. 10, the occurrence rate for successful and failure flows may be presented under column 1006. For example, success flows 1014 and 1016 and failure flows 1018, 1020, and 1022 may be shown as percentages of all flows under column 1006. The occurrence of successful and failure flows shown in column 1006 may be obtained from tracking facility 106, or alternatively, may be entered by a user. In some embodiments, the total percentage for all flows in column 1006 sums to 100%. The occurrence rate values in column 1006 may be used to derive weighted averages of loading factors for services, as described below.

Additionally, section 1002 of GUI 1000 may include usage factor columns 1008, 1010, and 1012 that include usage factors for various services used in one or more of flows 1014-1022. For example, services S1, S2, and S3 may be represented in columns 1008, 1010, and 1012, respectively. Columns 1008-1012 may include fields indicating usage factors associated with each of services S1-S3 in each type of successful flows 1016 and 1018 and failure flows 1018, 1020, and 1022. Services S1-S3 may represent various services provided as part of each type of flow. For example, a telecommunication product may utilize a caller identification lookup as service S1, a destination number lookup as service S2, and a determination of the type of user telecommunication device as service S3.

The usage factors may indicate the relative frequencies with which each type of service is utilized in the respective product flows. For example, “successful flow 1” may be associated with a service S2 usage factor of 3, indicating that service S2 is utilized more often than services S1 and S3 during “successful flow 1.” In some examples, the product usage factors associated with each service in a product usage scenario may indicate the number of times the service is used in the scenario. For example, as shown in FIG. 10, service S1 may be utilized one time, service S2 may be utilized 3 times, and service S3 may be utilized 2 times in each instance of successful flow 1. As shown in FIG. 10, some services may have a usage factor of zero in certain failure flows, indicating that the services are not provided at all during the corresponding failure flows. For example, as shown in FIG. 10, “failure flow 3” may be associated with a service S1 usage factor of zero, indicating that service S1 is not provided during failure flow 3.

As shown in FIG. 10, section 1002 of GUI 1000 may also include a “composite usage factor” row 1024 that shows composite usage factors (e.g., weighted usage factors) for each of the plurality of services represented in columns 1008-1012. The composite usage factors may represent proportional usage factors for each service over all types of product flows associated with the product. For example, composite usage factors for each of services S1, S2, and S3 may be determined by multiplying the occurrence rate listed in column 1006 for each flow type and the corresponding loading factors of service S1, S2, and S3 listed in columns 1008-1012 for each of the flow types. The calculated multiplication products may then be summed for each of services S1, S2, and S3 to obtain the respective composite usage factors shown in row 1024.

Additional GUIs may be provided by capacity management subsystem 100 to enable a user to change stored properties of products, such as properties entered into GUIs 900 and 1000 and stored in storage facility 110 of subsystem 100. For example, as shown in FIG. 7, configuration column 704 may include a “change product” option and a “remove product” option. When a user selects the “change product” option from configuration column 704, for example, a “change product” GUI may be presented to the user that allows the user to select a name of a stored product from a menu, such as a drop-down menu. Once a desired product is selected, the user may be presented with fields showing the current configuration properties of the product, such as the properties illustrated in GUIs 900 and/or 1000 shown in FIGS. 9 and 10. The user may be given the option to leave field values as they are or make changes as desired, while being prevented from changing certain values, such as the product name. Additionally, the user may add or remove services and/or product usage scenarios associated with the selected product. The user may also be provided with a field to enter an effective date for the changes to the product.

In some examples, when a user selects the “remove product” option from configuration column 704 of GUI 700, a “remove product” GUI may be presented to the user that allows the user to select a name of a stored product associated with a stored product from a menu, such as a drop-down menu. Once a desired product is selected, the user may be presented with an option to remove the selected product. The user may also be provided with a field to enter an effective date for removing to the product. In some examples, once the user submits a request to remove a product, capacity management subsystem 100 may be updated with a “NotInService” status for the product so that the removed product is not used in any capacity or cost computation after the effective date. In some examples, a product record associated with the product may remain in the database for historic reporting purposes.

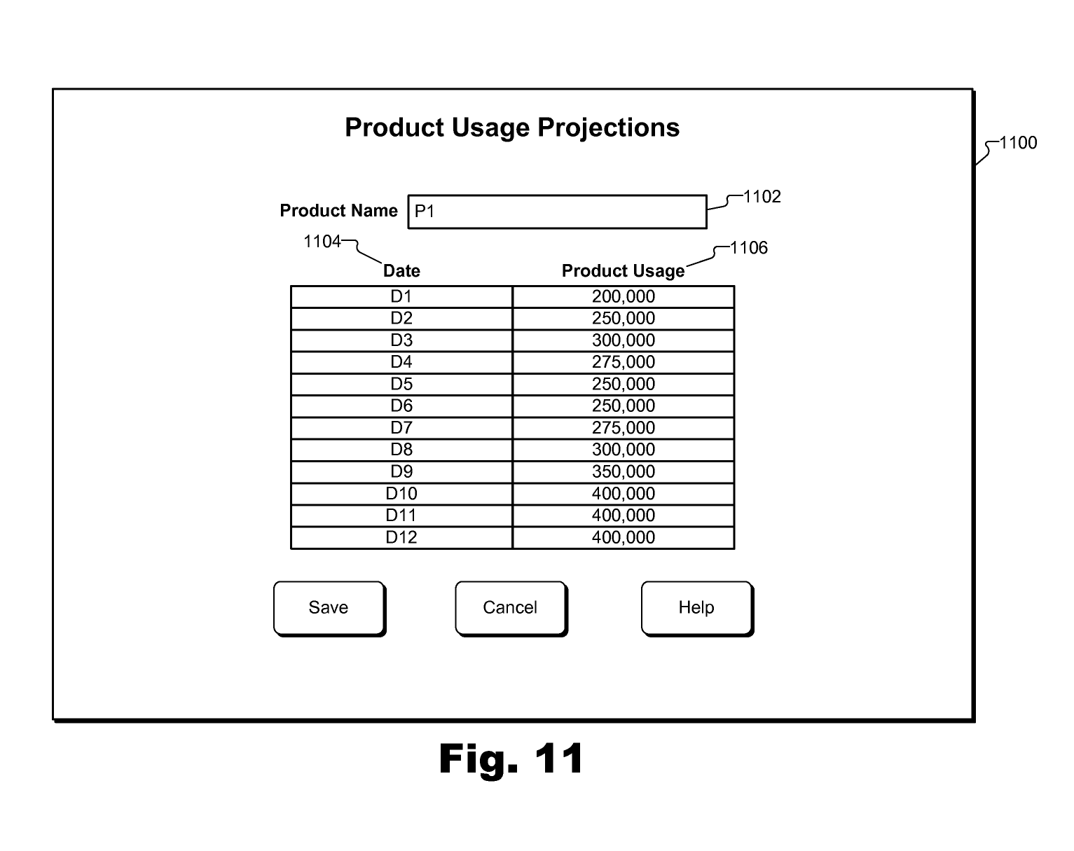

In some examples, a user may select a “product usage projections” option from configuration column 704 of GUI 700 illustrated in FIG. 7. FIG. 11 shows a “product usage projections” GUI 1100 that may be provided by subsystem 100 in response to a user selecting the “product usage projections” option for the purpose of defining usage projections.

As shown in FIG. 11, GUI 1100 may include a “product name” field 1102 for entering the name of a product. A product name, such as product P1, may be entered into field 1102 and/or may be selected from a dropdown menu associated with field 1102. Once a product selected or entered, if product usage configuration data and/or tracked data for the product exists in capacity management subsystem 100, the existing data may be displayed in the GUI 1100.

If usage projection is being added for the first time, GUI 100 may display a form having fields for entering data concerning product usage projections for the product. For example, GUI 1100 may include a “date” column 1104 and a “product usage” column 1106. In some embodiments, columns 1104 and 1106 may each include twelve rows, such that one row is provided for each calendar month starting from the month in which GUI 1100 is accessed. The fields under “date” column 1104 may include dates for desired usage data, such as one date for each month. Column 1104 may include dates in YYYY-MM-DD format so that service usage projections can be made precisely on a per day basis covering seasonal peaks and valleys. In some examples, data can be input for up to twelve distinct dates.

The fields under “product usage” column 1106 may be provided for the user to input projected usage data for the product. The product usage data entered in each field of column 1106 may represent product usage data for a time period associated with the corresponding date in column 1104. In some examples, if the projection is being defined for the first time for the product, no data may be displayed under “product usage” column 1106. In some embodiments, product usage values entered in column 1104 may be identical for all days from one date to another date in chronological order.

Product usage data that has been previously entered in association with the product may be displayed in some of the fields under column 1106, while additional fields under column 1106 for which data has not been entered may remain blank until data is entered by the user. If a usage value in a row of column 1106 is different from a previous row, the value can be specified. In some embodiments, if a particular row of column 1106 is left blank, usage data from a previous non-blank row may be automatically entered. The user may be required to add an entry into at least the first row of column 1106. If the user is editing the values in column 1106, the user may have the option to update the usage data.

The product usage values under product usage column 1106 may indicate the number of times the product is delivered by the system over the course of a selected interval during a defined time period. For example, the interval can be per second, per busy hour, per day, per week, or per month. The user may define the interval for the product usage values or the interval may be predefined in the system. In some embodiments, the interval is uniform for all the products tracked by capacity management subsystem 100.

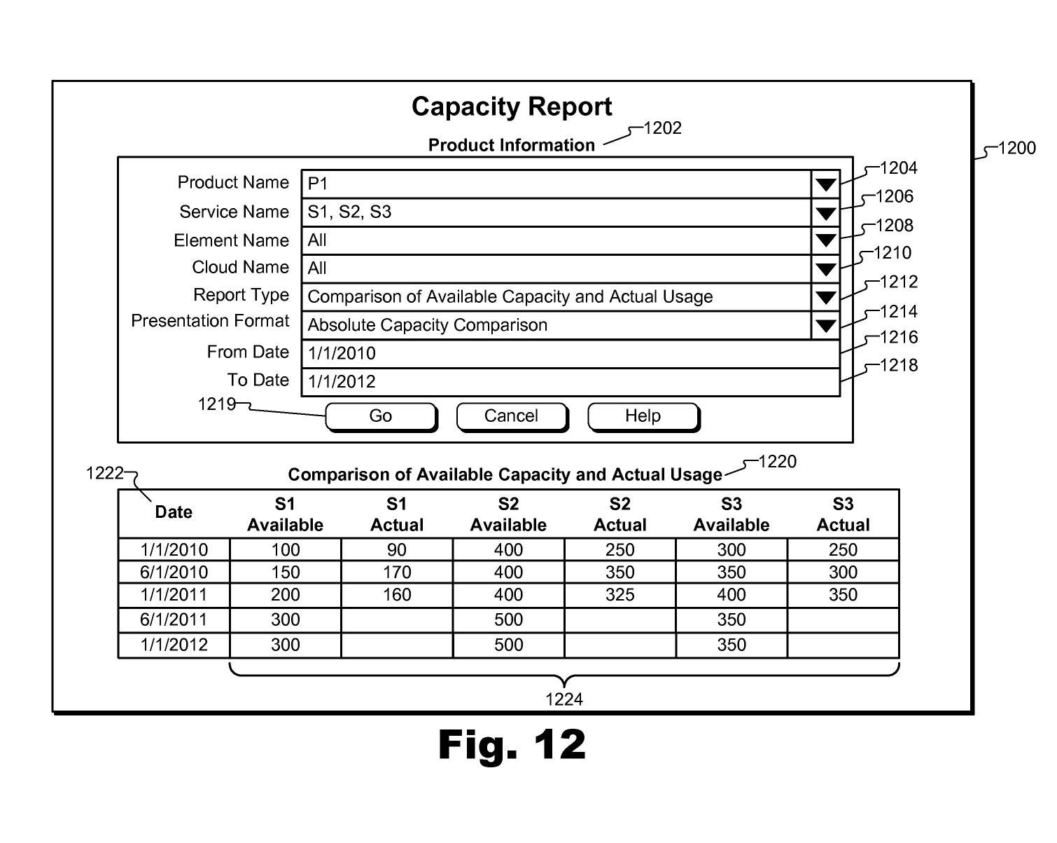

In some examples, a user may select a “capacity report” option from reports column 706 of GUI 700 illustrated in FIG. 7. For example, FIG. 12 shows a “capacity report” GUI 1200 that may be provided by subsystem 100 in response to a user selecting a “capacity report” option for the purpose of preparing a capacity report.

As shown in FIG. 12, various input fields for entering information for generating a specified report may be presented within a “product information” section 1202 of GUI 1200. Section 1202 may include a “product name” field 1204 for inputting a name of a product for which a report is to be generated. A product name, such as product P1, may be entered into field 1204 and/or may be selected from a dropdown menu associated with field 1204. Once a product is selected or entered, if product usage configuration data and/or tracked data for the product exists in capacity management subsystem 100, the existing data may be displayed in the GUI 1200. Services that are utilized in delivering the selected product and that are to be included in the report may be entered into “service name” field 1206 and/or may be selected from a dropdown menu associated with field 1206. In some examples, the services shown in field 1206 may be automatically generated upon selection of the product in field 1204.

Section 1202 may also include an “element name” field 1208 for entering and/or selecting one or more names of elements providing the services listed in field 1206 and a “cloud name” field 1210 for entering and/or selecting one or more names of cloud-based networks that include the listed elements. As shown in FIG. 12, the user may simply select or enter “all” in field 1208 and/or 1210 to indicate that all elements and/or cloud-based networks associated with the selected product and services are selected. Fields 1208 and 1210 may be used to specify which elements and/or clouds-based networks are included in the data used to generate the capacity report.

Additionally, a “report type” field 1212 and a “presentation format” field 1214 may be included in section 1202. The user may enter and/or select a type of capacity report to be generated in field 1212 and a type of format for presenting the report in field 1214. In some examples, a user may select from various types of reports, including “comparison of available capacity and actual usage,” “comparison of available capacity and projected usage,” “comparison of projected capacity and actual usage,” and “comparison of available, projected, and actual usage.” For example, FIG. 12 illustrates a situation where the user selects the “comparison of available capacity and actual usage” report type. A user may also select from various types of presentation formats, including, for example, an “absolute capacity comparison” and a “percentage capacity comparison.” For example, as shown in FIG. 12, if the user selects the “absolute capacity comparison” presentation format in field 1214, the report may present the system capacity numbers as absolute numbers. The “absolute comparison” presentation format may be useful, by way of example, for analyzing changes in system capacity and/or for analyzing system capacity that is available for product growth. Section 1202 may further include a “from date” field 1216 and a “to date” field 1218 for entering a date range to be analyzed for the report. The user may enter a beginning date for analysis in “from date” field 1216 and an end date in “to date” field 1218. The system may analyze and present data falling within selected date range.

Once the required fields are filled in section 1202, the user may select “go” option 1219 to bring up one or more capacity reports associated with the entries input by the user in section 1202. For example, subsystem 100 may generate a graphical representation of analyzed data associated with the selected product, services, elements, and/or clouds. The contents of the report may vary depending on the parameters selected by the user in section 1202. In some examples, when the user selects “go” option 1219, a “comparison of available capacity and actual usage” section 1220 may be displayed in GUI 1200 and/or a separate GUI. Section 1220 may include fields in column format for displaying data associated with the selected product, services, elements, and/or clouds. For example, section 1220 may include a “date” column 1222 and one or more “capacity data” columns 1224. The date column 1222 may show dates within the selected date range for the report. In some examples, the interval and/or format of the dates may be specified by the user.

“Capacity data” columns 1224 may show available and actual service capacity values for each of the services selected in “service name” field 1206. In some examples, the values shown in “capacity data” columns 1224 may represent average capacity resource values during a time period beginning with the listed date. The available capacity values shown in columns 1224 may indicate the total system capacity resources available for providing each of the selected services based on capacity resources allocated to the services. The available capacity values may be projections that are determined based on user values input into capacity management subsystem 100. For example, user-entered capacity values and allocations may be used to generate the available capacity values during each time period. The actual capacity values shown in columns 1224 may indicate the actual system capacity resources utilized by the services. The actual capacity values may be determined based on actual resource usage during the selected time period. The actual capacity values may be determined from user input or from system usage tracked by tracking facility 106 of capacity management subsystem 100.

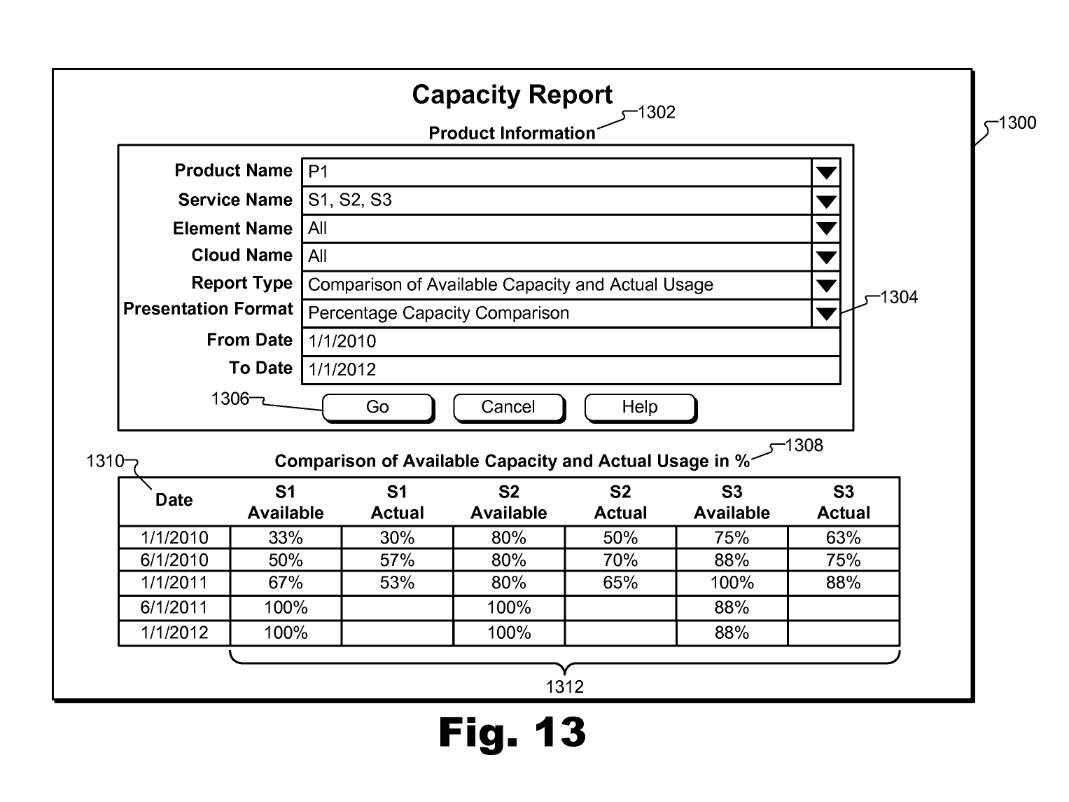

FIG. 13 illustrates another “capacity report” GUI 1300. As shown in FIG. 13, the user may select the “percentage capacity comparison” presentation format in “presentation format” field 1304 of “product information” section 1302. The “percentage capacity comparison” presentation format may be selected by the user to generate a report in which the system capacity numbers are presented as percentages. The “percentage capacity comparison” presentation format may be useful, by way of example, for performing analysis, traffic spike analysis, and/or cost benefit analysis.

Once the required fields are filled in section 1302, the user may select “go” option 1306 to bring up one or more capacity reports associated with the entries input by the user in section 1302. A “comparison of available capacity and actual usage in percentage (%)” section 1308 may be displayed in GUI 1300 and may include a “date” column 1310 and one or more “capacity information” columns 1312. “Capacity information” columns 1312 may show available and actual service capacity values for each of the selected services. The values shown in “capacity information” columns 1312 may be percentages that each represent a portion of the overall available capacity that is required by each of the respective services in the selected product during the corresponding time periods.

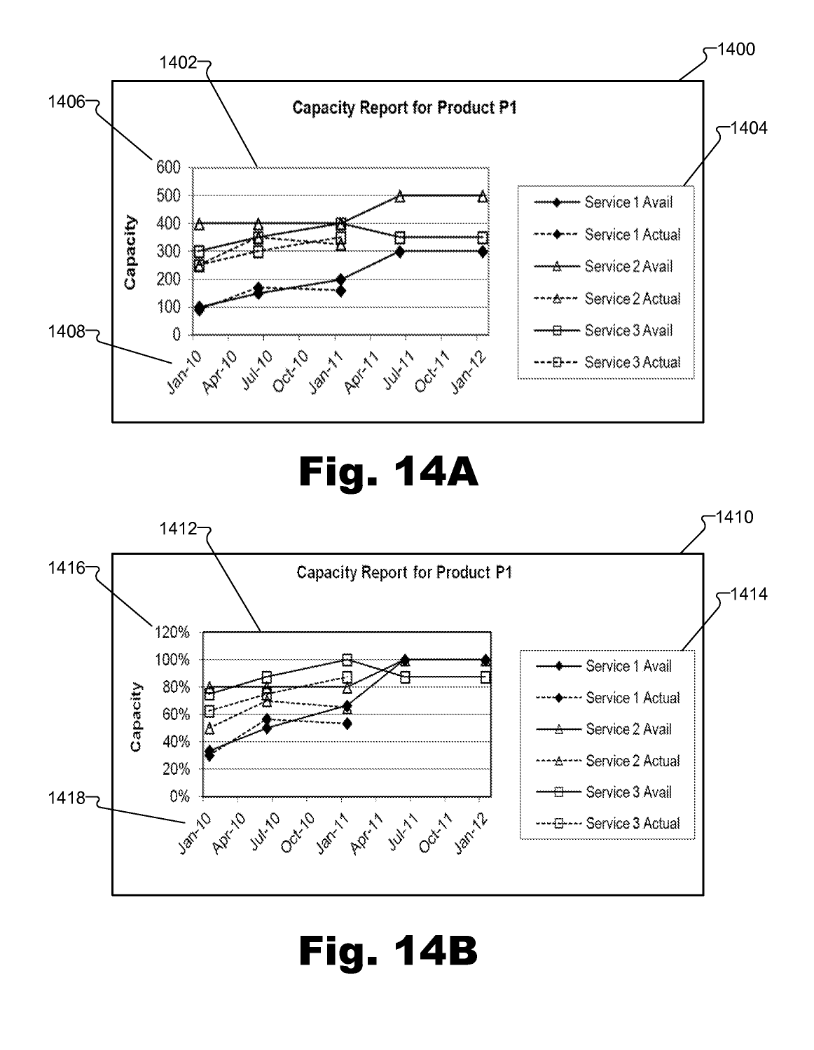

When the user completes a capacity report GUI, such as capacity report GUI 1200 or capacity report GUI 1300, capacity management subsystem 100 may generate a graphical display of data based on report parameters identified by the user. For example, FIG. 14A shows an exemplary graphical report 1400 that graphically represents data generated in “comparison of available capacity and actual usage” section 1220 of FIG. 12. As shown in FIG. 14A, graphical report 1400 may include graph section 1402 graphically showing data points associated with various services provided in association with a selected product. Graphical report 1400 may include a legend 1404 showing various services and the corresponding trend line and data point formats used in graph section 1402. Additionally, graphical report 1400 may include a capacity axis 1406 indicating a capacity value range for graph section 1402 and a date axis 1408 indicating a date range for graph section 1402.

FIG. 14B shows an exemplary graphical report 1410 that graphically represents data generated in “comparison of available capacity and actual usage in percentage (%)” section 1308 of FIG. 13. As shown in FIG. 14B, graphical report 1410 may include graph section 1412 graphically showing data points associated with various services provided in association with a selected product. Graphical report 1410 may include a legend 1414, a capacity axis 1416 indicating a capacity percentage range for graph section 1412, and a date axis 1418 indicating a date range for graph section 1412.

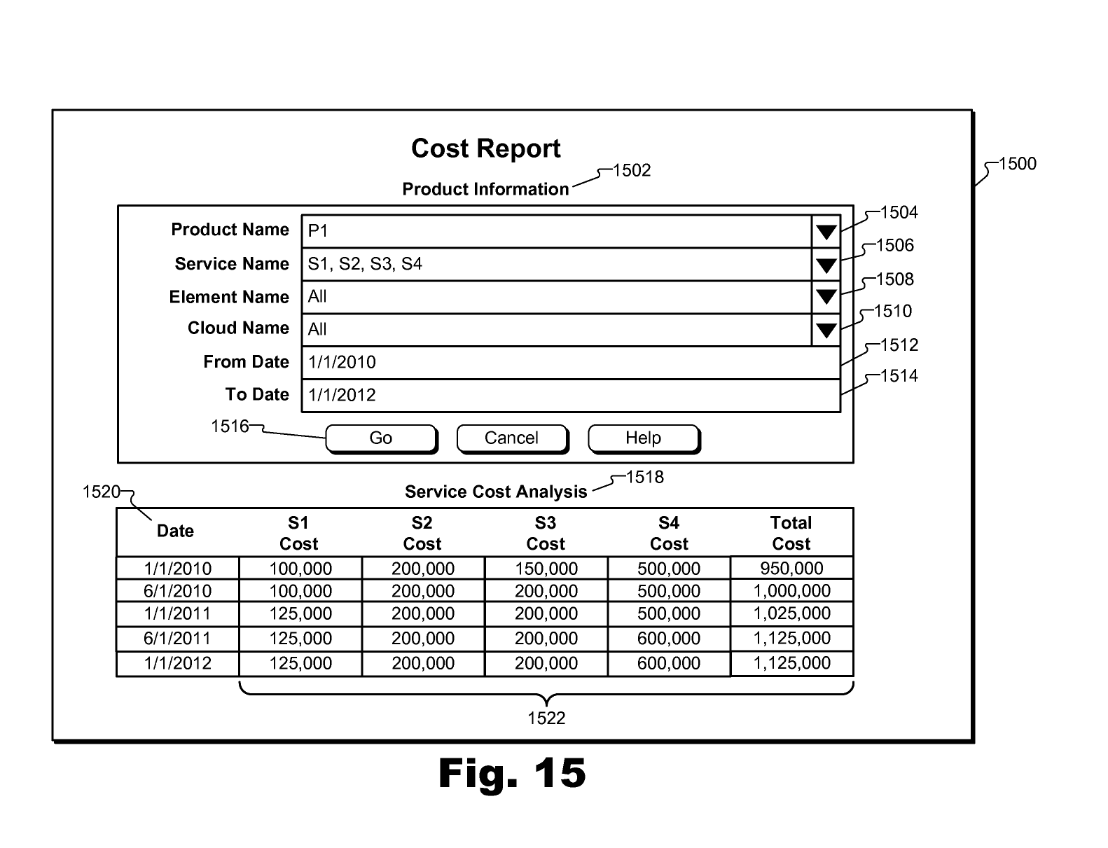

In some examples, a user may select a “cost report” option from reports column 706 of GUI 700 illustrated in FIG. 7. FIG. 15 shows a “cost report” GUI 1500 that may be provided by subsystem 100 in response to a user selecting a “cost report” option for the purpose of preparing a cost report.

As shown in FIG. 15, various input fields for entering information for generating a specified report may be presented within a “product information” section 1502 of GUI 1500. Section 1502 may include a “product name” field 1504, a “service name” field 1506, an “element name” field 1508, a “cloud name” field 1510, a “from date” field 1512, and a “to date” field 1514. Once the required fields are filled in section 1502, the user may select “go” option 1516 to bring up one or more cost reports associated with the entries input by the user. For example, subsystem 100 may generate a data report and/or a graphical representation of analyzed data associated with the selected product, services, elements, and/or clouds.

The contents of the cost report may vary depending on the parameters selected by the user in section 1502. In some examples, when the user selects “go” option 1516, a “service cost analysis” section 1518 may be displayed in GUI 1500 and/or a separate GUI. Section 1518 may include fields in column format for displaying data associated with the selected product, services, elements, and/or clouds. For example, section 1518 may include a “date” column 1520 and one or more “service cost” columns 1522.

“Service cost” columns 1522 may show individual and total costs for providing each of the services selected in “service name” field 1506. In some examples, the costs shown in columns 1522 may represent costs of using the services during time periods beginning with the dates listed in column 1516. In some examples, the costs associated with each of the services may be determined from the system capacities apportioned to the corresponding services and the costs of operating the system elements providing the services. In some examples, the cost may be determined based on cost and capacity usage values stored in storage facility 110 of capacity management subsystem 100.

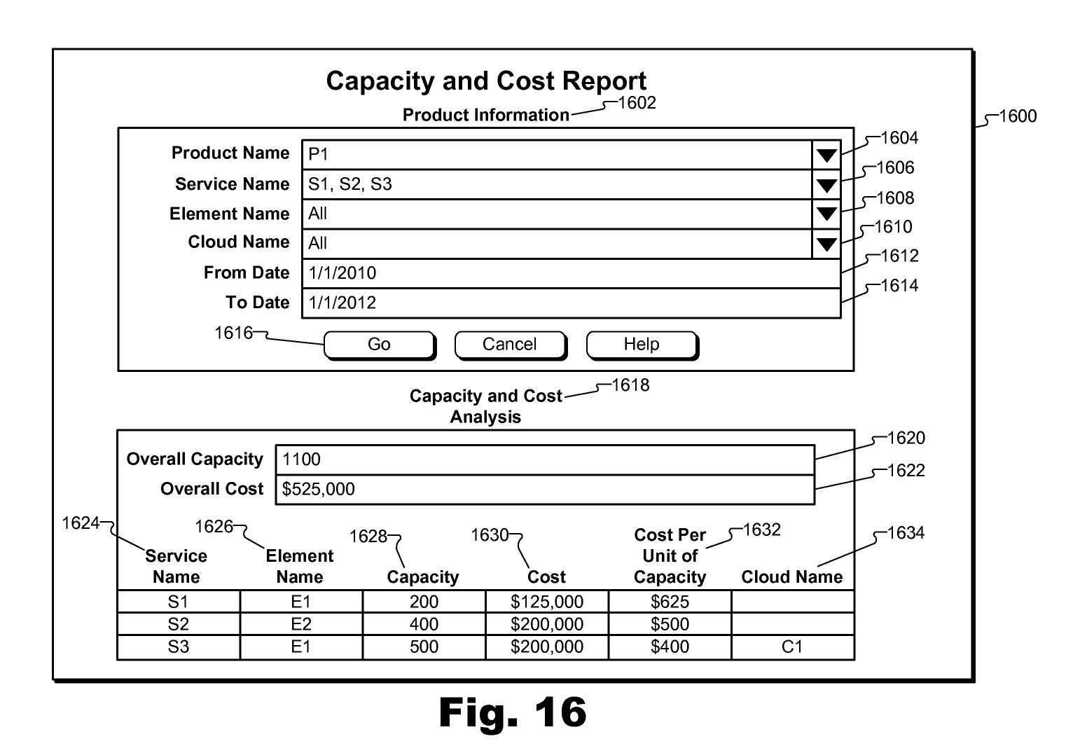

In some embodiments, capacity and cost information for a product may be provided in a single report. FIG. 16 shows a “capacity and cost report” GUI 1600 that may be provided by subsystem 100 in response to a user selecting a “capacity and cost report” option from reports column 706 of GUI 700 illustrated in FIG. 7.

As shown in FIG. 16, various input fields for entering information for generating a specified report may be presented within a “product information” section 1602 of GUI 1600. Section 1602 may include a “product name” field 1604, a “service name” field 1606, an “element name” field 1608, a “cloud name” field 1610, a “from date” field 1612, and a “to date” field 1614.

Once the required fields are filled in section 1602, the user may select “go” option 1616 to bring up one or more cost reports associated with the entries input by the user. For example, subsystem 100 may generate a data report and/or a graphical representation of analyzed data associated with the selected product, services, elements, and/or clouds. The contents of the report may vary depending on the parameters selected by the user in section 1602. In some examples, when the user selects “go” option 1616, a “capacity and cost analysis” section 1618 may be displayed in GUI 1600 and/or a separate GUI. As shown in FIG. 16, section 1618 may include an “overall capacity” field 1620 that shows an overall system capacity allocated to the selected product during the selected time period. Additionally, section 1618 may include an “overall cost” field 1622 that shows an overall operating cost for providing the product during the selected time period. In some examples, the overall capacity and the overall cost shown in section 1618 may represent an average periodic capacity and cost during the specified time period. For example, the overall capacity shown in field 1620 may be an average capacity on a per month basis, and the overall cost shown in field 1622 may be an average cost for providing the selected product on a per month basis. The overall capacity and the overall cost may be determined based on data previously entered and stored in subsystem 100 in association with the selected product and corresponding services, elements, and/or cloud-based networks.

Section 1618 may also include one or more columns showing various capacity and cost data for the selected product and services. For example, section 1618 may include a “service name” column 1624 that includes a separate row for each of the selected services associated with the selected product. An “element name” column 1626 may include the names of elements providing each of the corresponding services listed in “service name” column 1624. A “capacity” column 1628 may show the portion of the overall system capacity that is allocated to each of the corresponding services listed in column 1624. A “cost” column 1630 may show the portion of the overall operating cost of providing each of the corresponding services listed in column 1624. In some examples, section 1618 may also include a “cost per unit of capacity” column 1632 that shows the cost to provide each unit of system capacity for each of the corresponding services. Section 1618 may also include a “cloud name” column 1634 for indicating any cloud-based networks that include elements providing the corresponding services. In some examples, the capacity and cost values shown in columns 1628, 1620, and 1632 may represent average system capacity values and costs on a periodic basis, such as a monthly basis.

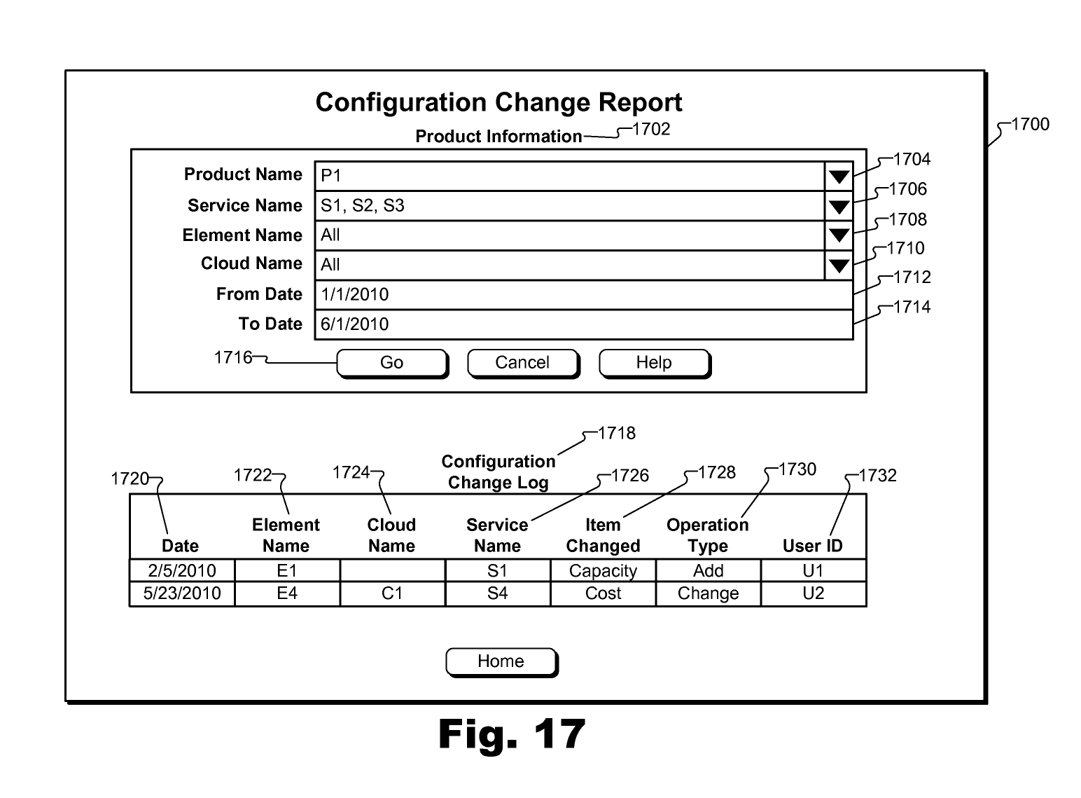

System 100 may also provide reports detailing various changes made to element and product configuration parameters. For example, FIG. 17 shows a “configuration change report” GUI 1700 that may be provided by subsystem 100 in response to a user selecting a “configuration change report” option from “reports” column 706 of GUI 700 illustrated in FIG. 7.

As shown in FIG. 17, various input fields for entering information for generating a specified report may be presented within a “product information” section 1702 of GUI 1700. Section 1702 may include a “product name” field 1704, a “service name” field 1706, an “element name” field 1708, a “cloud name” field 1710, a “from date” field 1712, and a “to date” field 1714 for entering a date range to be analyzed for the report.

Once the required fields are filled in section 1702, the user may select “go” option 1716 to bring up a “configuration change log” section 1718 in GUI 1700 and/or a separate GUI. As shown in FIG. 17, section 1718 may present information in column format showing changes made during a selected time period. Section 1718 may include a “date” column 1720 showing dates on which various configuration changes were made. An “element name” column 1722, a “cloud name” column 1724, and a “service name” column 1726 may be provided to show elements, cloud-based networks, and services associated with the configuration changes made on the corresponding dates. An “item changed” column 1728 may be provided to show what configuration parameter was changed on each of the corresponding dates and an “operation type” column 1730 may be provided to show what type of change was made to the corresponding parameter. For example, as shown in FIG. 17, column 1728 may show the term “capacity” in a row of column 1728 and the term “add” in a corresponding row of column 1730, thereby indicating that capacity allocated to service S1 was added to the configuration information associated with element. A “user ID” column 1732 may be provided to identify a user who executed each associated configuration change.

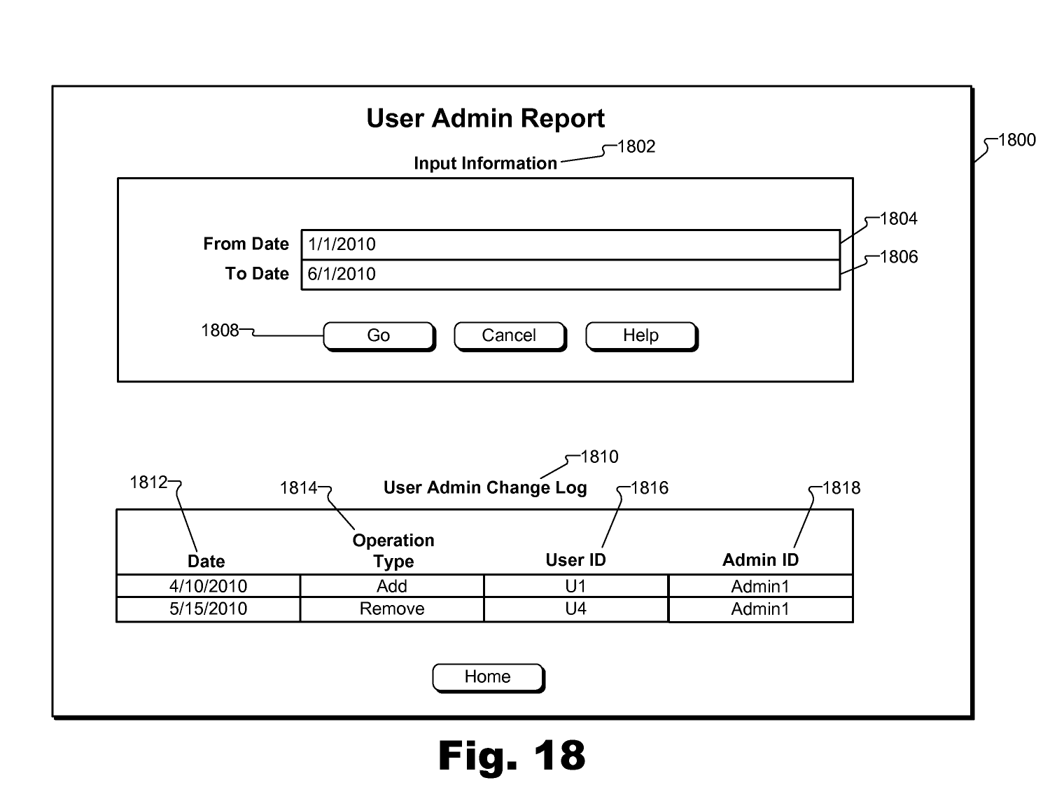

FIG. 18 shows a “user admin report” GUI 1800 that may be provided by subsystem 100 in response to a user selecting a “user admin report” option from “reports” column 706 of GUI 700 illustrated in FIG. 7.

As shown in FIG. 18, an “input information” section 1802 may include a “from date” field 1804 and a “to date” field 1806 for entering a date range to be analyzed for the report. The user may select “go” option 1808 to bring up a “user admin change log” section 1810 in GUI 1800 and/or a separate GUI. As shown in FIG. 18, section 1810 may include a “date” column 1812 showing dates on which various configuration changes were made. Section 1810 may also include an “operation type” column 1814 to show what type of operation was performed on each of the corresponding dates, a “user ID” column 1816 to identify a user ID affected by each operation type, and an “admin ID” column 1818 to identify an administrator who performed each corresponding operation type. For example, as shown in FIG. 18, columns 1814, 1816, and 1818 may indicate that user ID “U1” was added and user ID “U4” was removed by an administrator associated admin ID “Admin1.”

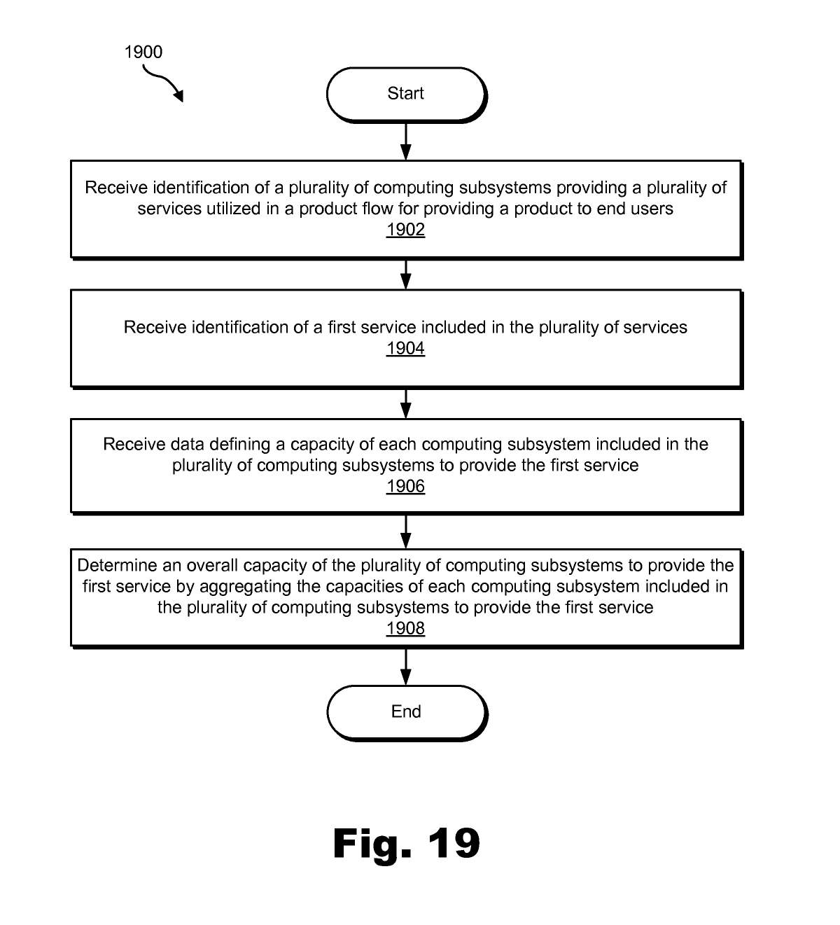

FIG. 19 illustrates another exemplary capacity management method 1900. While FIG. 19 illustrates exemplary steps according to one embodiment, other embodiments may omit, add to, reorder, and/or modify any of the steps shown in FIG. 19. One or more of the steps shown in FIG. 19 may be performed by subsystem 100 and/or any implementation thereof.

In step 1902, a capacity management subsystem receives identification of a plurality of computing subsystems providing a plurality of services utilized in a product flow for providing a product to end users. Step 1902 may be performed in any of the ways described herein. For example, a user may use add element GUIs, such as add element GUI 800 illustrated in FIG. 8, to identify various computing subsystems, such as computing subsystems 202 illustrated in FIGS. 2, 3, and 5. In some examples, the user may enter the name of the computing subsystem (e.g., “computing subsystem 1”) into element name field 804 of an add element GUI 800 for each computing subsystem. A separate add element GUI 800 may be used for identifying each of the plurality of computing subsystems.

In step 1904, the capacity management subsystem receives identification of a first service included in the plurality of services. For example, the user may identify a first service provided by each computing subsystem by entering the first service name (e.g., service “S1”) in service name column 814 of each corresponding GUI 800.

In step 1906, the capacity management subsystem receives data defining a capacity of each computing subsystem included in the plurality of computing subsystems to provide the first service. Step 1906 may be performed in any of the ways described herein. For example, the user may enter a service capacity of each computing subsystem to provide service “S1” into service capacity column 816 of each corresponding GUI 800. In some examples, the user may also enter a loading factor associated with service “S1” into loading factor column 818 of each corresponding GUI 800, thereby identifying the percentage of each computing subsystem allocated to providing service “S1”. Capacity management subsystem 100 may use the entered service capacities and loading factors for service “S1” to define the overall capacity of each computing subsystem to provide service “S1”.

In step 1908, the capacity management subsystem determines an overall capacity of the plurality of computing subsystems to provide the first service by aggregating the capacities of each computing subsystem included in the plurality of computing subsystems to provide the first service. Step 1908 may be performed in any of the ways described herein. For example, capacity management subsystem 100 may aggregate the capacities of each of the plurality of computing subsystems to determine an overall capacity of the plurality of computing subsystems to provide service “S1”. In some examples, the overall capacity of the plurality of computing subsystems to provide service “S1” may be summarized in a capacity report, such as a report generated and presented in capacity report GUI 1200 shown in FIG. 12. For example, section 1220 of GUI 1200 may display available capacities of a plurality of computing subsystems to provide service “S1” during various time periods.

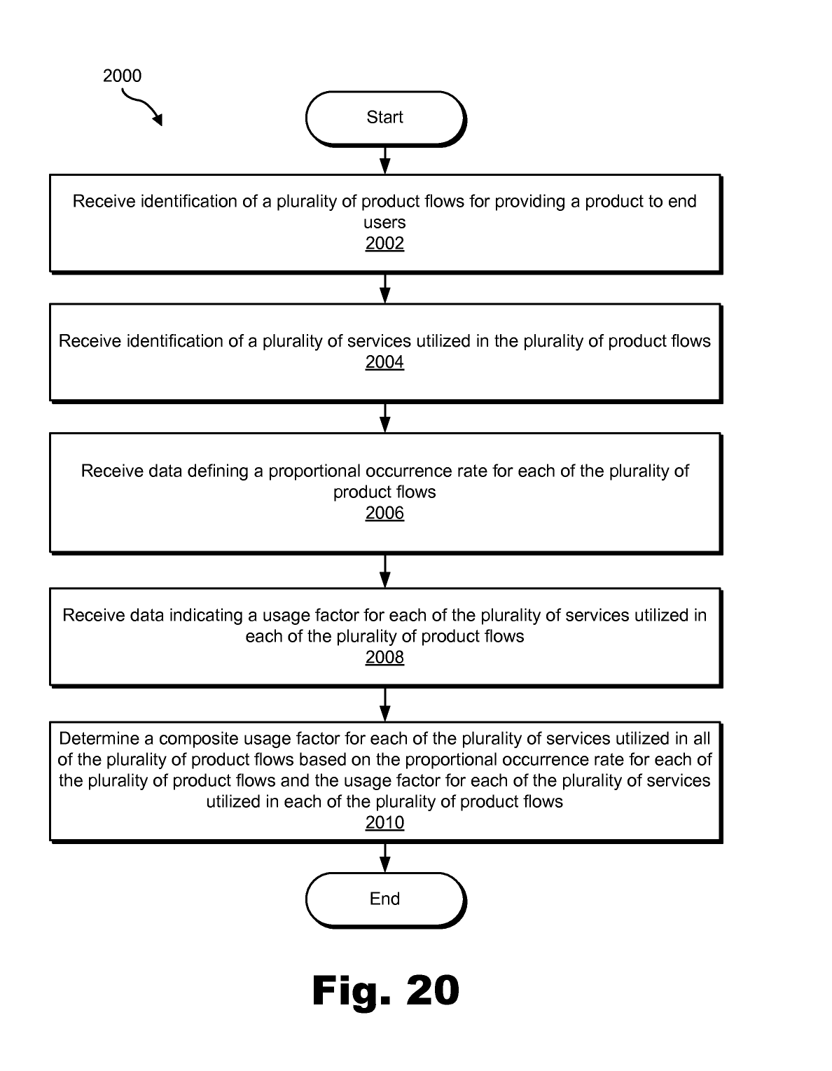

FIG. 20 illustrates another capacity management method 2000. While FIG. 20 illustrates exemplary steps according to one embodiment, other embodiments may omit, add to, reorder, and/or modify any of the steps shown in FIG. 20. One or more of the steps shown in FIG. 20 may be performed by subsystem 100 and/or any implementation thereof.

In step 2002, a capacity management subsystem receives identification of a plurality of product flows for providing a product to end users. Step 2002 may be performed in any of the ways described herein. For example, a user may use add product GUIs, such as add product GUIs 900 and 1000 illustrated in FIGS. 9 and 10, to identify various product flows 1016-1022 for providing a product (e.g., product “P1”). In some examples, the various product flows may include successful flows, which result in successful delivery of the product to an end user, or failure flows, which result in only partial delivery of the product.

In step 2004, the capacity management subsystem receives identification of a plurality of services utilized in the plurality of product flows. Step 2004 may be performed in any of the ways described herein. For example, the user may identify various services utilized in product “P1,” such as services “S1,” “S2,” and “S3” selected in service fields 906-910 of GUI 900.

In step 2006, the capacity management subsystem receives data defining a proportional occurrence rate for each of the plurality of product flows. Step 2006 may be performed in any of the ways described herein. For example, as shown in FIG. 10, proportional occurrence rates for each of the product flows may be entered into the “% occurrence” column 1006 of GUI 1000. The proportional occurrence rates in column 1006 may represent the frequency with which each of the product flows occurs when a network circuit-based product is delivered to an end user.

In step 2008, the capacity management subsystem receives data indicating a usage factor for each of the plurality of services utilized in each of the plurality of product flows. Step 2008 may be performed in any of the ways described herein. For example, usage factors for each of services “S1,” “S2,” and “S3” in the corresponding product flows may be entered into usage factor columns 1008-1012. The usage factors may indicate the relative frequencies with which each type of service is utilized in the respective product flows.

In step 2010, the capacity management subsystem determines a composite usage factor for each of the plurality of services utilized in all of the plurality of product flows based on the proportional occurrence rate for each of the plurality of product flows and the usage factor for each of the plurality of services utilized in each of the plurality of product flows. Step 2010 may be performed in any of the ways described herein. For example, capacity management subsystem 100 may utilize the proportional occurrence rates in column 1006 and the usage factors for each of services “S1,” “S2,” and “S3” in columns 1008-1012 to determine composite usage factors for each of services “S1,” “S2,” and “S3.” In some examples, the composite usage factors may represent proportional usage factors for each service over all types of product flows associated with the corresponding product.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

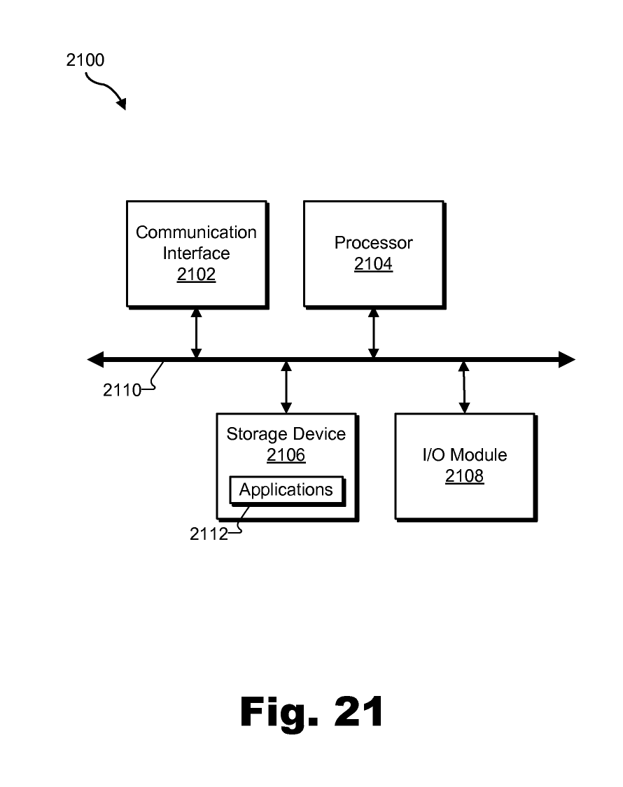

FIG. 21 illustrates an exemplary computing device 2100 that may be configured to perform one or more of the processes described herein. As shown in FIG. 21, computing device 2100 may include a communication interface 2102, a processor 2104, a storage device 2106, and an input/output (“I/O”) module 2108 communicatively connected via a communication infrastructure 2110. While an exemplary computing device 2100 is shown in FIG. 21, the components illustrated in FIG. 21 are not intended to be limiting. Additional or alternative components may be used in other embodiments. Components of computing device 2100 shown in FIG. 21 will now be described in additional detail.

Communication interface 2102 may be configured to communicate with one or more computing devices. Examples of communication interface 2102 include, without limitation, a wired network interface (such as a network interface card), a wireless network interface (such as a wireless network interface card), a modem, an audio/video connection, and any other suitable interface.

Processor 2104 generally represents any type or form of processing unit capable of processing data or interpreting, executing, and/or directing execution of one or more of the instructions, processes, and/or operations described herein. Processor 2104 may direct execution of operations in accordance with one or more applications 2112 or other computer-executable instructions such as may be stored in storage device 2106 or another computer-readable medium.

Storage device 2106 may include one or more data storage media, devices, or configurations and may employ any type, form, and combination of data storage media and/or device. For example, storage device 2106 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 2106. For example, data representative of one or more executable applications 2112 configured to direct processor 2104 to perform any of the operations described herein may be stored within storage device 2106. In some examples, data may be arranged in one or more databases residing within storage device 2106.

I/O module 2108 may be configured to receive user input and provide user output and may include any hardware, firmware, software, or combination thereof supportive of input and output capabilities. For example, I/O module 2108 may include hardware and/or software for capturing user input, including, but not limited to, a keyboard or keypad, a touch screen component (e.g., touch screen display), a receiver (e.g., an RF or infrared receiver), and/or one or more input buttons.

I/O module 2108 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 2108 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 2100. For example, one or more applications 2112 residing within storage device 2106 may be configured to direct processor 2104 to perform one or more processes or functions associated with capacity management facility 102, identification facility 104, tracking facility 106, and/or reporting facility 108. Likewise, storage facility 110 may be implemented by or within storage device 2106.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
receiving, by a capacity management subsystem, identification of a first computing subsystem included in a plurality of computing subsystems;
receiving, by the capacity management subsystem, identification of a plurality of services provided by the first computing subsystem, the plurality of services utilized in a product flow for providing a product to end users;
receiving, by the capacity management subsystem, data defining, for each service included in the plurality of services, an apportioned capacity of the first computing subsystem to provide the service, wherein each apportioned capacity of the first computing subsystem comprises a portion of an overall resource capacity of the first computing subsystem;
receiving, by the capacity management subsystem, data defining an overall operating cost of the first computing subsystem; and
determining, by the capacity management subsystem, an operating cost of providing each service included in the plurality of services by the first computing subsystem based on the apportioned capacity of the first computing subsystem to provide each service included in the plurality of services and the overall operating cost of the first computing subsystem.

2. The method of claim 1, further comprising:
receiving, by the capacity management subsystem, identification of a second computing subsystem included in the plurality of computing subsystems;
receiving, by the capacity management subsystem, identification of at least one service included in the plurality of services utilized in the product flow, the at least one service being provided by the second computing subsystem;
receiving, by the capacity management subsystem, data defining, for each service included in the at least one service, an apportioned capacity of the second computing subsystem to provide the service, wherein each apportioned capacity of the second computing subsystem comprises a portion of an overall resource capacity of the second computing subsystem;
receiving, by the capacity management subsystem, data defining an overall operating cost of the second computing subsystem; and
determining, by the capacity management subsystem, an operating cost of providing each service included in the at least one service by the second computing subsystem based on the apportioned capacity of the second computing subsystem to provide each service included in the at least one service and the overall operating cost of the second computing subsystem.

3. The method of claim 2, further comprising aggregating, by the capacity management subsystem, the operating cost of providing each service included in the plurality of services by the first computing subsystem and the operating cost of providing each service included in the at least one service by the second computing subsystem.

4. The method of claim 1, further comprising providing, by the capacity management subsystem, a graphical user interface (“GUI”) to a user, wherein at least one of the identification of the first computing subsystem, the identification of the plurality of services provided by the first computing subsystem, the data defining, for each service included in the plurality of services, the apportioned capacity of the first computing subsystem to provide the service, and the data defining the overall operating cost of the first computing subsystem is received from the user via the GUI.

5. The method of claim 1, wherein the receiving of the data defining, for each service included in the plurality of services, the apportioned capacity of the first computing subsystem to provide the service and the receiving of the data defining the overall operating cost of the first computing subsystem further comprises receiving the data from a tracking agent located on the first computing subsystem.

6. The method of claim 1, further comprising generating, by the capacity management subsystem, a graphical analysis of the operating cost of providing each service included in the plurality of services by the first computing subsystem.

7. The method of claim 1, further comprising:
receiving, by a product delivery subsystem, a request for the product;
providing, by the product delivery subsystem, the services in a specified sequence on at least one computing subsystem included in the plurality of computing subsystems in response to the request for the product.

8. The method of claim 1, wherein the plurality of computing subsystems comprises at least one computing subsystem located in a first cloud-based network and at least another computing subsystem located in a second cloud-based network.

9. The method of claim 1, embodied as computer-executable instructions on at least one non-transitory computer-readable medium.

10. A method comprising:
receiving, by a capacity management subsystem, identification of a plurality of computing subsystems providing a plurality of services utilized in a product flow for providing a product to end users;
receiving, by the capacity management subsystem, identification of a first service included in the plurality of services;
receiving, by the capacity management subsystem, data defining a capacity of each computing subsystem included in the plurality of computing subsystems to provide the first service; and
determining, by the capacity management subsystem, an overall capacity of the plurality of computing subsystems to provide the first service by aggregating the capacities of each computing subsystem included in the plurality of computing subsystems to provide the first service.

11. The method of claim 10, further comprising receiving, by the capacity management subsystem, identification of a second service included in the plurality of services;
receiving, by the capacity management subsystem, data defining a capacity of each computing subsystem included in the plurality of computing subsystems to provide the second service; and
determining, by the capacity management subsystem, an overall capacity of the plurality of computing subsystems to provide the second service by aggregating the capacities of each computing subsystem included in the plurality of computing subsystems to provide the second service.

12. The method of claim 10, further comprising generating, by the capacity management subsystem, a graphical analysis of the overall capacity of the plurality of computing subsystems to provide the first service.

13. The method of claim 12, wherein the graphical analysis illustrates a comparison between the overall capacity of the plurality of computing subsystems to provide the first service and a projected overall usage of the first service during a specified time period.

14. The method of claim 10, wherein the receiving of the data defining the capacity is performed during a plurality of different time periods.

15. The method of claim 10, further comprising providing, by the capacity management subsystem, a graphical user interface (“GUI”) to a user, wherein at least one of the identification of the plurality of computing subsystems providing the plurality of services utilized in the product flow for providing the product to the end users, the identification of the first service included in the plurality of services, and the data defining the capacity of each computing subsystem included in the plurality of computing subsystems to provide the first service is received from the user via the GUI.

16. The method of claim 10, embodied as computer-executable instructions on at least one non-transitory computer-readable medium.

17. A method comprising:
receiving, by a capacity management subsystem, identification of a plurality of product flows for providing a product to end users;
receiving, by the capacity management subsystem, identification of a plurality of services utilized in the plurality of product flows;
receiving, by the capacity management subsystem, data defining a proportional occurrence rate for each of the plurality of product flows;
receiving, by the capacity management subsystem, data indicating a usage factor for each of the plurality of services utilized in each of the plurality of product flows; and
determining, by the capacity management subsystem, a composite usage factor for each of the plurality of services utilized in all of the plurality of product flows based on the proportional occurrence rate for each of the plurality of product flows and the usage factor for each of the plurality of services utilized in each of the plurality of product flows.

18. The method of claim 17, wherein the usage factors each represent a utilization frequency for a respective service included in the plurality of services.

19. The method of claim 17, wherein the plurality of product flows each represent a discrete product flow initiated in response to a respective request for the product.

20. The method of claim 17, further comprising providing, by the capacity management subsystem, a graphical user interface (“GUI”) to a user, wherein at least one of the identification of the plurality of product flows, the identification of the plurality of services utilized in the plurality of product flows, the data defining the proportional occurrence rate for each of the plurality of product flows, and the data indicating the usage factor for each of the plurality of services utilized in each of the plurality of product flows is received from the user via the GUI.

21. The method of claim 17, embodied as computer-executable instructions on at least one non-transitory computer-readable medium.

22. A system comprising:
an identification facility configured to:
receive identification of a first computing subsystem included in a plurality of computing subsystems; and
receive identification of a plurality of services provided by the first computing subsystem, the plurality of services utilized in a product flow for providing a product to end users; and
a capacity management facility communicatively coupled to the identification facility and configured to:
receive data defining, for each service included in the plurality of services, an apportioned capacity of the first computing subsystem to provide the service, wherein each apportioned capacity of the first computing subsystem comprises a portion of an overall resource capacity of the first computing subsystem;
receive data defining an overall operating cost of the first computing subsystem; and
determine an operating cost of providing each service included in the plurality of services by the first computing subsystem based on the apportioned capacity of the first computing subsystem to provide each service included in the plurality of services and the overall operating cost of the first computing subsystem.

23. The system of claim 22, wherein the identification facility is further configured to provide a graphical user interface (“GUI”) to a user, wherein at least one of the identification of the first computing subsystem, the identification of the plurality of services provided by the first computing subsystem, the data defining, for each service included in the plurality of services, the apportioned capacity of the first computing subsystem to provide the service, and the data defining the overall operating cost of the first computing subsystem is received from the user via the GUI.

24. The system of claim 22, further comprising a reporting facility communicatively coupled to the capacity management facility and configured to generate a graphical analysis of the operating cost of providing each service included in the plurality of services by the first computing subsystem.
